(19) United States
(12) Patent Application Publication
(10) Pub. No.: US 2023/0043318 A1
(43) Pub. Date: Feb. 9, 2023

(54) CLIENT-PROVISIONED CREDENTIALS FOR ACCESSING THIRD-PARTY DATA

(71) Applicant: Block, Inc., San Francisco, CA (US)

(72) Inventors: Samir Selman, Sunny Isles Beach, FL (US); Joshua Schwarzapel, Millbrae, CA (US); Brian Gorby, Mill Valley, CA (US); Patrick Tyska, Brooklyn, NY (US)

(21) Appl. No.: 17/874,872

(22) Filed: Jul. 27, 2022

Related U.S. Application Data
(60) Provisional application No. 63/226,738, filed on Jul. 28, 2021.

(51) Int. Cl. G06F 21/31; G06F 21/60; G06F 21/62

(52) U.S. Cl. CPC G06F 21/31; G06F 21/602; G06F 21/6209

(57) ABSTRACT

Accessing third-party service provider data on behalf of a first-party service provider without having to provide credentials to a first-party service provider server(s) is described. A credential may be received via a user interface presented by a mobile payment application associated with a service provider, the credential being associated with a user account of a user and a third-party service provider. The mobile payment application may then send the credential to a computing device(s) of the third-party service provider, which causes a session to be established between the mobile payment application and the third-party device(s). The mobile payment application may receive, via the session, user data associated with the user account from the third-party device(s), and may send, without having provided the credential to a computing device(s) of the service provider, at least a portion of the user data to the computing device(s) of the service provider.

### CROSS REFERENCE TO RELATED APPLICATION

This patent application claims priority to U.S. Provisional Patent Application Ser. No. 63/226,738, filed Jul. 28, 2021, which is hereby incorporated in its entirety by reference.

### TECHNICAL FIELD

When a first-party service provider wants to access data stored and/or maintained by a third-party service provider, existing techniques utilize scraping technologies and/or application programming interfaces (APIs). Scraping technologies allow users to sign into their third-party service provider accounts and transfer relevant information to another application associated with a service provider (e.g., a first-party service provider). In such examples, the first-party service provider, through aggregators, can log into the third-party application as if it were a user, “scrape” the relevant data, and paste it into their own platform. APIs function as conduits that connect service providers. An API connection allows associated computing devices to talk to each other utilizing a common format.

### BRIEF DESCRIPTION OF THE DRAWINGS

Features of the present disclosure, its nature and various advantages, will be more apparent upon consideration of the following detailed description, taken in conjunction with the accompanying drawings.

FIG. 1 is an example system for accessing third-party service provider data without having to provide credentials to a first-party service provider server(s) and/or other third-party service provider server(s), according to an implementation of the present subject matter.

FIG. 2 is an example system for dynamically determining whether to send a credential to a third-party service provider server(s) indirectly via a first-party service provider server(s) to access third-party service provider data, according to an implementation of the present subject matter.

FIG. 3 is an example signal flow diagram illustrating a technique for accessing third-party service provider data without having to provide credentials to a first-party service provider server(s) and/or other third-party service provider server(s), according to an implementation of the present subject matter.

FIG. 4 is an example process for accessing third-party service provider data without having to provide credentials to a first-party service provider server(s) and/or other third-party service provider server(s), according to an implementation of the present subject matter.

FIG. 5 is an example process for initiating an authentication of a user and/or a mobile payment application based on a request to obtain specific data, according to an implementation of the present subject matter.

FIG. 6 is an example process for dynamically determining whether to send a credential to a third-party service provider server(s) indirectly via a first-party service provider server(s) to access third-party service provider data, according to an implementation of the present subject matter.

FIG. 7 is an example process for verifying eligibility of a mobile application to access third-party service provider data, according to an implementation of the present subject matter.

FIG. 8 is an example environment for performing techniques described herein.

FIG. 9 is an example environment for performing techniques described herein.

FIG. 10 is an example data store used for performing techniques described herein.

FIG. 11 is an example environment for performing techniques described herein.

FIG. 12 is an example block diagram illustrating a system for performing techniques described herein.

In the figures, the left-most digit(s) of a reference number identifies the figure in which the reference number first appears. The use of the same reference numbers in different figures indicates similar or identical items or features. The drawings are not to scale.

### DETAILED DESCRIPTION

Techniques described herein offer improved techniques for safe, secure methods for first-party service providers to access (e.g., retrieve) user data, such as payroll data, insurance data, financial data, etc., from third-party service providers server(s) without users having to transmit credentials to server(s) (i.e., first-party service provider server(s)) and/or other third-party service provider server(s). That is, in conventional techniques, when a first-party service provider wants to access data stored and/or maintained by a third-party service provider, scraping technologies and/or application programming interfaces (APIs) are used. Scraping technologies allow users to sign into their third-party service provider accounts and transfer relevant information to another application associated with a service provider (e.g., a first-party service provider). In such examples, the first-party service provider, through aggregators, can log into the third-party application as if it were a user, “scrape” the relevant data, and paste it into their own platform. API connections allow associated computing devices to talk to each other utilizing a common format. As described herein, in conventional techniques, a user provides their credential to another entity (e.g., the first-party service provider and/or an intermediary) to enable the other entity to access the user's data. This can undermine security and expose the user to fraudulent and/or bad actors. Techniques described herein relate to enabling credentials (e.g., passwords, security keys, log-in data, passcodes, single sign-ons (SSOs), personal identification numbers (PINs), etc.) to be provisioned by clients directly to third-party service providers to enable first-party service providers to access data stored and/or maintained by the third-party service providers, without users having to provide their credentials to the first-party service providers. As such, techniques described herein offer safer, more secure methods for first-party service providers to access user data.

Techniques described herein can be applicable to various third-party service providers and/or user data stored and/or maintained by such third-party service providers. For example, payroll service providers store payroll data such as income data, employment data, and/or the like. In some examples, payroll data stored by payroll service providers can indicate recipients (e.g., target accounts) of direct deposit funds. With regard to payroll service providers, payroll service providers have access controls that limit other service providers from accessing their data (e.g., payroll data associated with end-users of the payroll service providers). This limited access prevents users, such as employees, from accessing their payroll data, such as time and attendance data, via open APIs and authentication standards (e.g. OAuth). Instead, in existing techniques, users use assigned credentials to access this data via a web browser or the payroll service provider's own application.

In some examples, a service provider (i.e., a first-party service provider) providing banking services, payroll services, payment services, insurance services, and/or the like can desire to access such payroll data, which can be stored and/or maintained by a third-party service provider. In some examples, service providers providing alternative or supplemental services to payroll services can desire access to user payroll data so that users can withdraw earned wages, for example, or utilize the payroll data for other purposes. For example, a first-party service provider wanting to access payroll data from a third-party payroll service provider can request a user provide a credential for accessing a user account associated with the third-party payroll service provider. By accessing the user account associated with the third-party payroll service provider, the first-party service provider can access payroll data of the user. In existing techniques, such service providers (i.e., first-party service providers) rely on users inputting their credentials to access the payroll data of the user. Many companies utilize SSO to enable users to use a single set of credentials to access everything from email to documents to payroll. Given the highly sensitive nature of these credentials, storing the credentials outside of a controlled (e.g., user-controlled) environment is a significant security risk and runs counter to many companies' internal security policies.

That is, in existing techniques, the first-party service provider can receive a credential from a client of a user and can use the credential to access a user account and, in the example where the credential is associated with a third-party payroll service provider, payroll data associated therewith. For example, when the first-party service provider receives the credential, the first-party service provider can establish a session from which the first-party service provider programmatically accesses payroll data for the user while the session is open. In existing techniques, the credentials can be stored by the first-party service provider temporarily or long term. However, credentials can be sensitive data such that many users (e.g., employees) and/or credential providers (e.g., employer credential providers, such as SSO) may not want to share their credentials or have their credentials stored by a first-party service provider for security and/or confidentiality reasons, as an example. Backend computing devices of service providers can often be targets of hackers, such that storage of sensitive credentials on such backend computing devices can cause such sensitive credentials to be accessible to such hackers. These security concerns are exponentially greater for credentials that are used across multiple service providers. As such, by providing such credentials to first-party service providers for use in accessing third-party service provider data, existing techniques can expose users to risk (e.g., theft of credentials and/or user data, such a payroll data, to which the credentials provide access).

Techniques described herein relate to an alternative approach to accessing third-party service provider data, by enabling a user to provide a credential directly to a third-party service provider via a client (e.g., computing device) of the user. In one implementation, the techniques are client-driven and server-directed. That is, the credential is stored locally on the client and may not be provided to the first-party service provider. The third-party service provider can use the credential provided by the user via the client to access an associated user account and related data and can provide the related data to the client. In some implementations, the first-party service provider may craft specific instructions (e.g., including details of authentication, the type of data per client device, the type of data per transaction, the type of data per mobile application, or other such variables) based on which the client can execute instructions embedded in a request from the first-party service provider and fetch appropriate related and contextual data from the third-party service provider using the credential. The client can then provide the related data to the first-party service provider. In some examples, the first-party service provider, the client device, and/or third-party payroll service provider can provide instructions to limit access to certain data, or to set preferences to how the data is shared with other applications installed on the client device and/or beyond the client device. For example, the third-party payroll service provider can control how long the session is authenticated, how long the session persists, and/or what kind of communication protocols exist between these entities. By controlling the parameters of the session and/or controlling access to certain types of data, security pertaining to sensitive data (e.g., mitigating risk of theft of credentials and/or sensitive data) is improved, and privacy of users is maintained.

In the example where the third-party service provider is a payroll service provider, a user associated with the third-party payroll service provider can provide the third-party payroll service provider a credential(s) associated with a user account of the user. The third-party payroll service provider can access the user account of the user and related payroll data. The third-party payroll service provider can provide the related payroll data to the client of the user, which can provide the related payroll data to the first-party service provider. That is, the client can serve as a conduit or proxy to providing payroll data associated with the user from the third-party payroll service provider to the first-party service provider without providing the first-party service provider the credential(s) associated with the user account of the user. As such, techniques described herein relate to improvements to existing techniques by offering more secure, less risky means for users to share relevant data, such as payroll data, from third-party service providers with first-party service providers.

As described above, techniques described herein provide improved security and mitigate risk in view of existing technologies. By enabling users to provide credentials directly to third-party service providers and by enabling clients to serve as conduits for providing third-party data to first-party service providers, techniques described herein alleviate the need for users to provide credentials to first-party service providers. By maintaining credentials locally on devices (e.g., client devices), techniques described herein reduce risks associated with hackers or other bad actors who target backend computing devices. Further, techniques described herein reduce risks of users being blocked from accessing third-party service providers and associated data. That is, in some examples, existing technologies block certain internet protocol (IP) addresses from accessing third-party service provider services. Techniques described herein would enable third-party service providers to block individual users instead of IP addresses or the like.

In one embodiment, systems and/or methods described herein can use a combination of techniques described herein. For example, the first-party service provider can dynamically determine whether to use a “local-credential”-based technique or a “distributed-credential”-based technique based on the type of credential, level of risk, and/or system preferences (e.g., how long a session needs to persist). For example, a first-party service provider server(s) may receive information about a credential associated with a user account of a user associated with a third-party service provider (i.e., without the first-party service provider server(s) actually receiving the credential), and the first-party service provider server(s) (e.g., a processor(s) thereof executing instructions) may determine a level of risk associated with the credential. If the level of risk is high (e.g., if the level of risk satisfies a threshold), the first-party service provider server(s) may dynamically determine to use a local-credential-based technique. As used herein, “dynamically determining” whether to use a local-credential- or a distributed-credential-based technique means using an automated process (e.g., a computer program, machine learning, etc.) to determine which technique to use, without user intervention, and in real-time, or near real-time. In the local-credential-based technique, the first-party service provider server(s) may send, to a mobile payment application executing on a client device of the user, an instruction for the mobile payment application to provision the credential to the third-party service provider directly (i.e., without providing the credential to the first-party service provider server(s)), which causes a session to be established between the mobile payment application and the third-party service provider server(s). During the session, the mobile payment application receives user data from the third-party service provider server(s) and forwards at least some of the user data to the first-party service provider server(s). On the other hand, if the first-party service provider server(s) determines that the level of risk associated with the user's credential is low (e.g., if the level of risk fails to satisfy the threshold), the first-party service provider server(s) may dynamically determine to use a distributed-credential-based technique, whereby the first-party service provider server(s) sends an instruction to the mobile payment application of the client device to provision the credential to the first-party service provider server(s), which the first-party service provider uses to access third-party service provider data directly from the third-party service provider server(s).

This dynamic decision-making technique can conserve computing resources. For example, for relatively low risk credentials, the computing resources that would otherwise be utilized to establish a secure session between the mobile payment application and the third-party service provider server(s) can be conserved and/or reserved for other, higher-risk credentials that warrant the utilization of those computing resources. A server-to-server API(s) used by the first-party service provider server(s) to access third-party service provider data directly from the third-party service provider server(s) may utilize comparatively fewer computing resources than the computing resources that are utilized for setting up, and maintaining, a secure session between a mobile payment application of a client device and the third-party service provider server(s).

As used herein, data transmission can be separate and distinct from authentication. Data transmission itself can encompass multiple elements; among them are availability, format, and transfer. Data availability refers to the specific fields (such as “payment amount” or “zip code”) that are offered through a data specification. Format describes how data is structured—JavaScript Object Notation (JSON) or Extensible Markup Language (XML), for instance. Finally, data transfer protocol refers to how data is moved. “Screen scraping,” for example, is a means of data collection; it does not imply a mechanism for authentication. In general, authentication and data transmission layers are interoperable. For example, in one example the methods and systems herein can combine OAuth, an authentication protocol, with “screen scraping,” a data transmission mechanism.

Further while embodiments described herein reference “access” to data, the description can be extended to cover other kinds of access and permission controls, including deauthorizing access to data or revoking previously authorized data access.

While techniques described herein relate to accessing payroll data from a third-party payroll service provider, techniques described herein can be similarly applicable to accessing third-party data from any third-party service provider. For example, techniques described herein can be applicable to accessing banking data, insurance data, social networking data, asset data (e.g., for securities, cryptocurrency, etc.), content data (e.g., music, video, podcast, etc.), and/or the like.

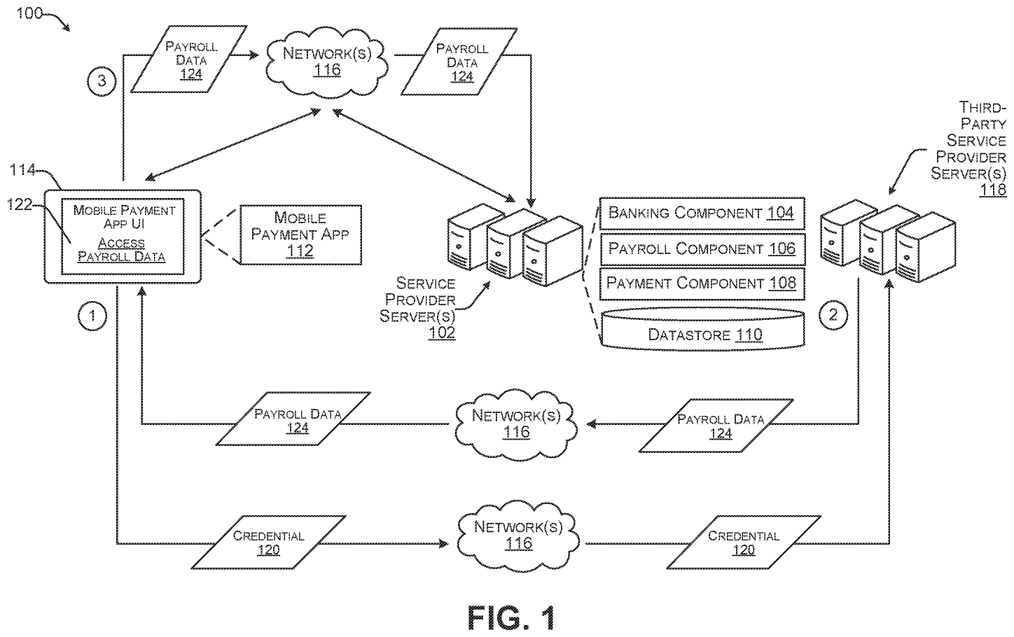

FIG. 1 illustrates an example system 100 for performing techniques described herein, such as for accessing third-party service provider data without having to provide credentials to a first-party service provider server(s) and/or other third-party service provider server(s). In FIG. 1, a service provider, associated with service provider server(s) 102, can provide one or more payment-related services, which can include banking services, payroll services, payment services, and/or the like. In some examples, the service provider server(s) 102 can include one or more functional components for providing such services, such as a banking component 104, a payroll component 106, and/or a payment component 108. The banking component 104 can provide banking services (e.g., deposits, withdrawals, savings management, account management, asset acquisitions, lending, etc.), the payroll component 106 can provide payroll services (e.g., managing direct deposits, fund allocations, etc.), and the payment component 108 can provide payment services (e.g., peer-to-peer payment services, payment transfer services, etc.), as described herein. The service provider associated with the server(s) 102 can provide additional or alternative services as described below. In at least one example, the service provider server(s) 102 can include a datastore 110 for storing banking data, payroll data, payment data, user data, and/or the like. For the purposes of this discussion, the service provider associated with the service provider server(s) 102 can be a “first-party service provider.” Throughout this disclosure, including the Figures, “first-party” is sometimes abbreviated as “1P.”

In at least one example, the first-party service provider can provide a mobile payment application 112 (sometimes referred to herein as a “payment application 112” or a “client payment application 112”) to enable a user to access services of the service provider via their user computing device 114 (sometimes referred to herein as a “client 114” or a “client device 114”). In at least one example, the mobile payment application 112 and the service provider server(s) 102 can exchange data via one or more networks 116, such as a wide area network (WAN) (e.g., the Internet, a cellular network, etc.). In some examples, the first-party service provider associated with the server(s) 102 is different than a service provider that provides the mobile payment application 112. For example, there may be at least three service providers in some implementations of the techniques described herein: (i) a service provider that provides the mobile payment application 112, (ii) another service provider associated with the server(s) 102, and (iii) another service provider associated with the server(s) 118. In these examples, the mobile payment application 112 may be configured to exchange data with the server(s) 102 and with the server(s) 118 to implement the techniques described herein, notwithstanding the mobile payment application 112 having been provided by a service provider who does not operate or maintain the server(s) 102 or the server(s) 118. In such an implementation, the mobile payment application 112 may serve as an intermediary between the first-party service provider server(s) 102 and the third-party service provider server(s) 118. In some examples, the service provider server(s) 102 may be implemented as, or may include, a cloud-based computing architecture suitable for hosting and servicing the respective payment applications 112 executing on respective electronic devices 114 of users. In particular examples, the server(s) 102 may be implemented as a computing platform based on any suitable computing architecture, such as a Platform as a Service (PaaS) architecture, a Software as a Service (SaaS) architecture, an Infrastructure as a Service (IaaS), a Data as a Service (DaaS), a Compute as a Service (CaaS), or other similar cloud-based computing architecture (e.g., “X” as a Service (XaaS)).

In at least one example, the service provider server(s) 102 can utilize an API to send instructions to the mobile payment application 112 to direct the mobile payment application 112 to authenticate and/or fetch data from third-party service provider server(s) 118, as described below. As described below, the third-party service provider server(s) 118 can send instructions to the mobile payment application 112 and the mobile payment application 112 can send data back to the third-party service provider server(s) 118. In at least one example, a lightweight shared state can exist between the mobile payment application 112 and the first-party service provider server(s) 102 so that the service provider server(s) 102 knows how to direct the mobile payment application 112 as data is submitted to it. In some examples, the lightweight shared state can be associated with a session token, a lock (e.g., a synchronization primitive), or the like. For example, the mobile payment application 112 and the first-party service provider server(s) 102 may be configured to update, in synchronized fashion, a shared location in memory (e.g., memory of the user computing device 114, memory of the first-party service provider server(s) 102, and/or external memory that is accessible to both computing devices). For example, the mobile payment application 112 and the first-party service provider server(s) 102 can utilize a lock to update their respective states. To illustrate, when the mobile payment application 112 successfully authenticates with the third-party service provider, the mobile payment application 112 may obtain a lock to update (e.g., write) its state as “authenticated” in the shared memory location. Subsequently, upon receiving data (e.g., payroll data 124) via a session from the third-party service provider server(s) 118, the mobile payment application 112 may obtain the lock to again update its state as “data received” or the like. In this manner, the first-party service provider server(s) 102 can obtain the lock to read the state of the mobile payment application 112 at any time and may direct the mobile payment application 112 based at least in part on the read state. For example, the first-party service provider server(s) 102 may direct the mobile payment application 112 by sending instructions to the mobile payment application 112 to authenticate (e.g., using authentication details, as described herein), and/or to fetch data (e.g., using details of data fetching, as described herein). In at least one example, when the service provider server(s) 102 has data to satisfy a condition, the service provider server(s) 102 can process received data and return results to the mobile payment application 112. That is, in at least one example, in response to receiving a request from the mobile payment application 112 that requires data that the service provider server(s) 102 does not have access to, the service provider server(s) 102 can provide instructions to the mobile payment application 112 to authenticate and fetch sufficient data to satisfy the request.

The mobile payment application 112 can configure the user computing device 114 to receive data, send data, and/or avail one or more user interfaces to facilitate operations as described herein. In at least one example, the mobile payment application 112 and/or the user computing device 114 can comprise a “client,” as used herein. In at least one example, the mobile payment application 112 can access network resources associated with uniform resource locators (URLs) to access data which can be routed back to the first-party service provider server(s) 102. In some examples, the mobile payment application 112 can securely store data, such as credentials or other sensitive information, locally. Storing such data locally can enable authentication and fetching data faster than when such data is stored with the service provider server(s) 102, and it allows for performing such operations without sending the credential to the first-party service provider server(s) 102 and/or to other third-party service provider server(s).

In at least one example, the first-party service provider server(s) 102 can exchange data with one or more third-party service provider servers 118 via the one or more networks 116. The third-party service provider server(s) 118 can be associated with one or more third parties. For the purpose of illustration in FIG. 1, the third-party service provider server(s) 118 can be associated with a payroll service provider. In additional or alternative examples, the third-party service provider server(s) 118 can be associated with a banking entity, an insurance entity, a social network, an asset exchange network (e.g., for securities, cryptocurrency, etc.), and/or the like. Accordingly, for the purposes of this discussion, the service provider associated with the service provider server(s) 118 can be a “third-party service provider.” Throughout this disclosure, including the Figures, “third-party” is sometimes abbreviated as “3P.” The third-party service provider server(s) 118 can exchange data with the first-party service provider server(s) 102, as described above, and/or with the mobile payment application 112 via the network(s) 116.

In at least one example, a user can input a credential 120 via a user interface 122 presented by the mobile payment application 112. In some examples, the first-party service provider server(s) 102 can send an instruction to the mobile payment application 112, the instruction including information regarding how to complete authentication and fetch data, such as payroll data 124, from a particular service provider, such as a third-party payroll service provider. In some examples, the instruction can be sent to the user computing device 114 as an email, text message, a computer-executable instruction (e.g., code executable by the mobile payment application 112), or other notification. The credential 120 can comprise a password, a security key, log-in data, a passcode, a SSO, a PIN, etc. In an example, the credential 120 is stored by the mobile payment application 112 and may not be shared with the first-party service provider server(s) 102.

In some examples, fetching data can include fetching data specific to the instruction(s) generated by the first-party service provider server(s) 102 and/or fetching data associated with an image, screenshot, etc., of the data displayed on an interface of a web or mobile browser accessible via the credential. In the case of an image, screenshot, etc., the first-party service provider server(s) 102 may perform image recognition to extract relevant data. For example, the mobile payment application 112 may be used to capture a screenshot of data displayed on a user interface of user computing device 114, and the screenshot may be sent to the first-party service provider server(s) 102, which performs image recognition to extract the data from the screenshot.

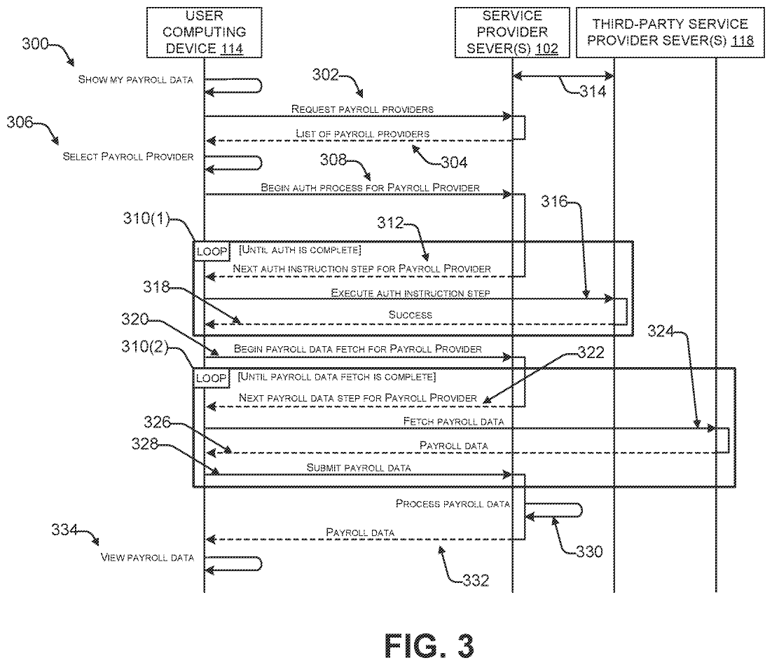

In at least one example, the mobile payment application 112 can send the credential 120 to the third-party service provider server(s) 118 via the network(s) 116, as illustrated by the encircled number one. In at least one example, when the credential 120 is provided to the third-party service provider server(s) 118, an authentication component associated with the third-party service provider server(s) 118 can use the credential 120 (and, in some cases, additional data provided therewith) to authenticate the user of the computing device 114 executing the mobile payment application 112 and/or to authenticate the mobile payment application 112. In some examples, the authentication component used by the third-party service provider server(s) 118 can be associated with an authentication service provider that authenticates a user to the third-party service provider (e.g., the third-party payroll service provider). In some examples, the authentication component can be external to the third-party service provider server(s) 118. In some examples, the authentication component can be integrated with the third-party service provider server(s) 118. Further detail about authentication is described below with reference to FIG. 3.

In at least one example, after the user is authenticated, a session can be established between the mobile payment application 112 and the third-party service provider server(s) 118. During this session, the mobile payment application 112 is able to access data, such as payroll data 124, from the third-party service provider server(s) 118 programmatically, as illustrated by the encircled number two. That is, a session can be established to enable the payroll data 124 to be fetched from the third-party service provider server(s) 118. In some examples, the session can be established (e.g., between the mobile payment application 112 and the third-party service provider server(s) 118) for a period of time, until an event occurs (e.g., a predetermined number of data transmissions, a predetermined amount of data transmitted, the mobile payment application 112 is closed or moved to the background, etc.), or the like. In some examples, the session can persist whether the mobile payment application 112 is running in the foreground or the background. In some examples, the mobile payment application 112 is running in the “foreground” if a user interface of the mobile application 112 is currently being displayed on the user computing device 114, and the mobile payment application 112 is running in the “background” if such a user interface of the mobile application 112 is not currently being displayed on the user computing device 114. In some examples, the third-party service provider data can be accessed via one or more APIs, a scraping component(s), and/or the like. “Scraping,” as used herein, can mean data scraping (sometimes referred to as “screen scraping”) where a computer program (e.g., scraping component(s)) extracts data from human-readable output provided by another program (e.g., a program associated with the third-party service provider server(s) that outputs human-readable output, such as payroll data 124 for display to an end-user). In some examples, the component(s) used for establishing the session and facilitating data exchange between the mobile payment application 112 and the third-party service provider server(s) 118 can be determined by the first-party service provider server(s) 102, based at least in part on data associated with the third-party service provider.

In some examples, the session can be established based at least in part on an instruction(s) sent from the first-party service provider server(s) 102 to the mobile payment application 112. In some examples, the instruction(s) sent from the first-party service provider server(s) 102 to the mobile payment application 112 may dictate the parameter(s) of the session established between the mobile payment application 112 and the third-party service provider server(s) 118. For example, the instruction received by the mobile payment application 112 from the first-party service provider server(s) 102 may specify a start time and/or a duration of the session, an event(s) that will cause the session to be terminated (e.g., a number of data transmissions, an amount of data transmitted, whether the mobile payment application 112 is closed or moved to the background, etc.), encryption protocol and/or networking protocol to use for the session, or the like. In some examples, the client (e.g., mobile payment application 112), upon establishing a session with the third-party service provider server(s) 118, serves as a conduit or proxy to providing data (e.g., payroll data 124) associated with the user from the third-party payroll service provider server(s) 118 to the first-party service provider server(s) 102 without providing the first-party service provider server(s) 102 the credential(s) 120 associated with the user account of the user. In some examples, such a conduit or proxy is implemented as a secure tunneling mechanism. That is, “establishing a session,” as used herein, can mean establishing a secure tunneling mechanism for data transfer between two trusted entities, such as the mobile payment application 112 and the third-party service provider server(s) 118. In some examples, the instructions sent from the first-party service provider server(s) 102 to the mobile payment application 112 include the parameter(s) of the secure tunneling mechanism, such as the use of an end-to-end encryption protocol (e.g., using Transport Layer Security (TLS) protocol).

The mobile payment application 112 may support a set of actions including sending network requests, displaying web pages or other user interfaces, and the like. In some examples, the mobile payment application 112 is configured to share results of those actions with the first-party service provider server(s) 102. Such results may include headers of network responses, content of the network responses, cookies (or other text files with small pieces of data—like a username and password—that can be used to identify a computer as being associated with a particular user while the user is using a computer network) set by displayed web pages, content of displayed web pages, and the like. The first-party service provider server(s) 102 may then compose a series of actions to perform a task or to retrieve information from the third-party service provider server(s) 118. For example, in order to retrieve paystubs from the third-party service provider server(s) 118, the first-party service provider server(s) 102 may instruct the mobile payment application 112 to display a login page of the third-party service provider and to share session cookies that are set after the user of the user computing device 114 logs in via the login page (e.g., using a credential(s) 120). Additionally, or alternatively, the first-party service provider server(s) 102 may instruct the mobile payment application 112 to send a request to the third-party service provider server(s) 118 for a paystub page and to share the response received by the mobile payment application 112. Additionally, or alternatively, the first-party service provider server(s) 102 may instruct the mobile payment application 112 to make one or more requests for individually-listed paystubs and to share the response(s) received by the mobile payment application 112. Additionally, or alternatively, the first-party service provider server(s) 102 may parse the paystub data (an example type of payroll data 124) and end the session.

In some examples, the mobile payment application 112 sends requests, such as the example requests described above, to the third-party service provider server(s) 118. That is, the mobile payment application 112 authenticates and communicates directly with the third-party service provider server(s) 118. The third-party service provider server(s) 118 instructs the mobile payment application 112 regarding which data to fetch, but does not fetch the data itself, and the third-party service provider server(s) 118 do not receive the credential(s) 120. In other examples, the first-party service provider server(s) 102 may take control from the mobile payment application 112 after the user successfully logs in (e.g., using the credential(s) 120), whereby the first-party service provider server(s) 102 sends subsequent requests to the third-party service provider server(s) 118 using session cookies shared by the mobile payment application 112. In such examples, the first-party service provider server(s) 102 may not receive the credential(s) 120. In some examples, a hybrid approach can be used such that communication and/or data transmissions are done via the mobile payment application 112 in some examples and by the first-party service provider server(s) 102 in other examples, which can be based on context in one or more examples. For instance, determining whether to use the mobile payment application 112 or the first-party service provider server(s) 102 can be based at least in part on network resource availability, type of data requested, whether session passing is supported, etc.

In some examples, authentication and “fetching” (e.g., during which the payroll data 124 is obtained via a session, as described above) can comprise one or more operations. That is, in some examples, authentication and “fetching” can be associated with a single operation and single instruction. In some examples, authentication and “fetching” can be associated with multiple operations and separate instructions. In some examples, when authentication and “fetching” is separated into multiple operations and instructions, the session can persist on the user computing device 114 securely storing cookies or tokens in the event the fetching operations are interrupted and retried. In some examples, the first-party service provider server(s) 102 can send instructions (1 . . . n) to the user computing device 114 until authentication and fetching operations are successfully completed. That is, the first-party service provider server(s) 102 can send instructions for individual operations as the mobile payment application 112 fulfills individual operations. In at least one example, data included with each of the instructions can be sufficient to enable the mobile payment application 112 to complete the operation, send results of the operation to the service provider server(s) 102, and move on to the next operation. In some examples, such instructions can depend on whether the first-party service provider utilizes an API (or not).

For a first-party service provider that does not have an API, this could include things like:

Type
E.g. “type: HTML”

URLs/methods for the client to access
E.g. GET https://payrollservice.com/myPayrollData/index.html

JavaScript actions to take when a URL completes a load
E.g. “Await for user input of username and password into form fields”

Response elements to submit back to the server
E.g. <div id=“weekly-paystub”>

For a first-party service provider that has API support, examples of instructions include, but are not limited to:

Type
E.g. “type: API”

URLs/methods for the API
E.g. GET https://payrollservice.com/api/v2/getPayrollData

Response elements to submit back to the server
E.g. “all”

The instructions and communication among the entities 102, 114, and 118 can also be based on other characteristics of the user computing device 114 and/or the third-party service provider server(s) 118. Negotiating communication may include creating instructions that conform to expected messages of the third-party service provider server(s) 118, for example. This can include setting headers, body contents, and other message properties. For example, the headers may include a host or path, a data, content type, cookies, media access control (MAC) address, a user identifier, authorization properties, and/or other suitable headers. Creating requests can additionally include transforming instructions into an expected form or communication protocol, which may include applying a set encryption pattern to the instructions and the response to the instructions. In one example, transforming the instructions involves encrypting content according to a public key, wherein the public key may be generated locally by the client device. In one implementation, the instructions can include following a request-response pattern. That pattern can involve a single instruction (request) and response, but may alternatively include a sequence of different requests and responses until desired information is obtained.

As illustrated by the encircled number three, the mobile payment application 112 can forward at least a portion of the received data (e.g., the payroll data 124) to the service provider server(s) 102 (i.e., the first-party service provider server(s)), wherein the service provider server(s) 102 can have one or more components stored thereon, as described above. In an example, the payroll data 124 can indicate paystub earnings categories (e.g., if a user is a 1099 or salaried employee), a paystub earnings amount, net pay amount, gross pay amount, shift earnings amount, shift earning hours, start and/or end dates associated with paystubs and/or shifts, direct deposit allocations, direct deposit amounts, direct deposit routing numbers, taxes, deductions, employment status (e.g., employed, termed, date termed, etc.), aggregations of aforementioned data, combinations of the aforementioned data, and/or the like. Such data (e.g., the payroll data 124) can be used by one or more components (e.g., the banking component 104, the payroll component 106, the payment component 108) to enable one or more services. As an example, the payroll data 124 can be used to indicate (e.g., via a user interface of the mobile payment application 112) a timing or an amount of a payroll payment, an account or accounts to which the payroll payment is to be made, and/or the like. In such an example, the banking component 104, the payroll component 106, and/or the payment component 108 can utilize such data in making determinations such as lending-related decisions, withdrawal-related decisions, and/or the like. For example, payroll data 124 may indicate an income of the user, and a loan can be offered to the user via the mobile payment application 112 (e.g., to purchase an item, to make a payment to another user, etc.) based on projected wages that are to be earned by the user based on past earned wages. In an illustrative example, a user may use the mobile payment application 112 to purchase an item available for sale from a merchant, and the payment component 108 may offer the user a buy now, pay later loan as a payment option. In this example, the determination to offer the loan and/or the terms of the loan may be based at least in part on the payroll data 124 forwarded to the first-party service provider server(s) 102 via the mobile payment application 112. In some examples, the payroll data 124 can be used for completing tax documents, such as tax returns, via the mobile payment application 112.

In some examples, payroll data 124 can be used to provide an “instant pay” service. That is, by analyzing payroll data 124 received from the third-party service provider server(s) 118, the payroll component 106 can enable the user to withdraw funds instantly without waiting for a normal payroll payment. For example, the payroll component 106 can enable a user to withdraw not-yet-paid earnings, which the payroll component 106 can recover (e.g., be repaid) from an upcoming payroll payment (e.g., paycheck) that is deposited into the user's account. In at least one example, the payroll component 106 can analyze payroll data 124 to estimate pay period boundaries associated with a user and paycheck dates. In conventional technologies, paychecks lag pay periods, which creates a time window at the beginning of a new pay period where a pay check from a previous pay period has not yet been deposited into a user's account. In some examples, the payroll component 106 can analyze payroll data 124 to infer pay period boundaries to estimate pay dates for pay periods. Using determined pay period boundaries and unpaid pay periods, the payroll component 106 can determine an amount of unpaid earnings and an amount a user is eligible for accessing early. That is, in at least one example, the payroll component 106 can calculate unpaid earnings per pay period, which in some examples, can be prior to deductions, taxes, and the like. In at least one example, the payroll component 106 can determine deductions, taxes, and the like from payroll data 124, apply deductions, taxes, and the like, and determine an amount available for instant payment to a user. In some examples, the available amount is intelligently determined by the payroll component 106 based at least in part on user data associated with the user. For example, the payroll component 106 can utilize a risk metric or another metric, which can be determined using one or more rules, machine-learning model(s), or the like, to determine an amount available for instant payment to the user. In some examples, the payroll component 106 can utilize one or more rules, such as limits, to determine an amount available for instant payment to the user. The available amount can be requested and/or deposited into the user's account prior to a direct deposit of a paycheck being received by the service provider. In an example, upon receipt of the direct deposit (e.g., via an Automated Clearing House (ACH) or other electronic funds transfer (EFT) deposit), the payroll component 106 can withhold a portion of the paycheck from being deposited into the user's account to cover the amount withdrawn instantly. In examples where the payroll component 106 determined an available amount to be greater than an amount deposited into the user's account, the payroll component 106 may withhold a portion of a next paycheck from being deposited into the user's account to cover the difference/error, and/or the payroll component 106 may cause a notification to be sent to the mobile payment application 112 informing the user that their paycheck didn't cover an amount of a recent instant payment, the notification requesting the user's permission to deduct the difference/error from funds in the user's account.

In some examples, the data received from the third-party service provider server(s) 118 can comprise structured data, unstructured data, image data, and/or the like. In some examples, the mobile payment application 112 can forward all of the data received from the third-party service provider server(s) 118 to the service provider server(s) 102. In some examples, the mobile payment application 112 can forward a portion of the data received from the third-party service provider server(s) 118 to the service provider server(s) 102. In some examples, the portion can be selected by the user. In some examples, the portion can be determined in response to a request for particular data made by the service provider server(s) 102. In some examples, the format of the data received by the mobile payment application 112 and forwarded to the service provider server(s) 102 can be based on the components used in establishing the session between the mobile payment application 112 and the third-party service provider server(s) 118. For example, a component used in establishing the session between the mobile payment application 112 and the third-party service provider server(s) 118 may cause data to be received by the mobile payment application 112 from the third-party service provider server(s) 118 in a first format (e.g., XML format), and the mobile payment application 112 may be configured to convert the data received in the first format (e.g., XML format) into a second format (e.g., JSON format) so that the data converted into the second format (e.g., JSON format) is formatted (e.g., standardized) for receipt and subsequent processing by the first-party service provider server(s) 102. For example, an application, a component, and/or computer-executable instructions executing on the first-party service provider server(s) 102 may be configured to receive and process data in a particular, target format (e.g., JSON format), and by converting data received in a different format (e.g., XML format) into the target format, the mobile payment application 112 can enable the first-party service provider server(s) 102 to interpret the forwarded data and perform one or more action(s) based at least in part on the forwarded data.

As described herein, the credential 120 provided by the user may not be provided to the first-party service provider server(s) 102 and/or may not be stored in association with the service provider server(s) 102. This can alleviate security concerns with existing systems, as described above, and can mitigate risk (e.g., the risk of theft of the credential 120 and/or sensitive data associated therewith). That is, by localizing credentials with the mobile payment application 112 (instead of provisioning the credentials to the first-party service provider server(s) 102), techniques described herein provide improvements to existing systems.

Although the payroll data 124 is shown in FIG. 1 as being sent to the mobile payment application 112 first, and subsequently forwarded by the mobile payment application 112 to the first-party service provider server(s) 102, it is to be appreciated that, in some examples, after the credential 120 is provisioned to the third-party service provider server(s) 118, the first-party service provider server(s) 102 may receive the payroll data 124 from the third-party service provider server(s) 118 directly, such as via an established session between the first-party service provider server(s) 102 and the third-party service provider server(s) 118.

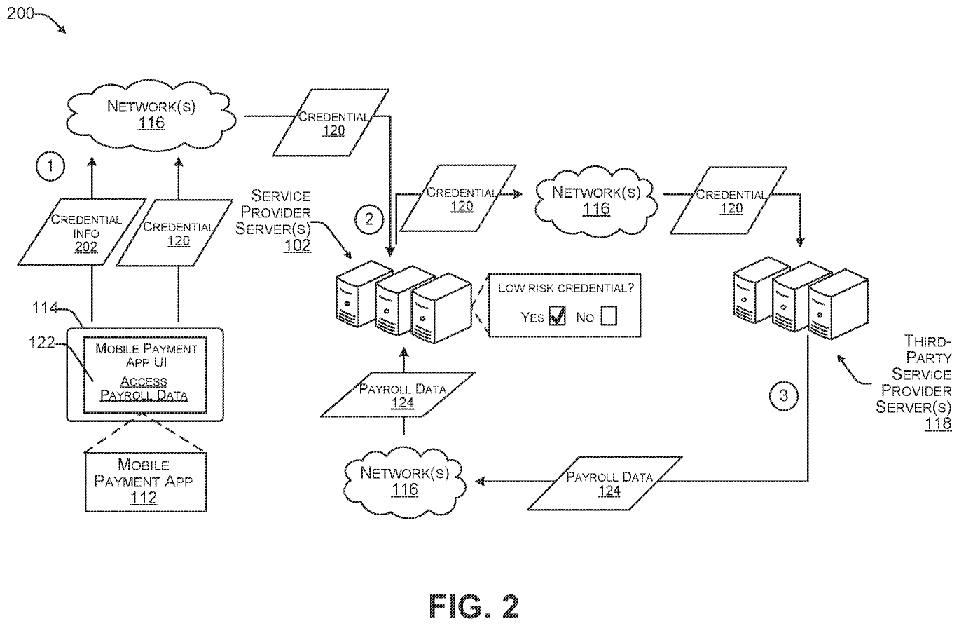

In some examples, as illustrated in FIG. 2, the mobile payment application 112 can, in some instances, provide the credential 120 to the service provider server(s) 102. In at least one example, a dynamic determination can be made as to whether to use a local-credential-based technique (e.g., the technique illustrated in FIG. 1) or a distributed-credential-based technique (e.g., the technique illustrated in FIG. 2). Said another way, a decision can be made as to whether the user (and/or the mobile payment application 112) should send the credential 120 to the third-party service provider server(s) 118 directly (without sending the credential 120 to the first-party service provider server(s) 102), as illustrated in FIG. 1, or whether the mobile payment application 112 should send the credential to the first-party service provider server(s) 102 so that the first-party service provider server(s) can receive, store, and/or send the credential 120 to the third-party service provider server(s) 118 to access third-party service provider data. Such a decision can be made by the first-party service provider server(s) 102, by the mobile application 112, by a combination thereof, and/or by another component of the system 200.

In some examples, such a decision can hinge on a determination of risk associated with a particular credential 120. Such a determination of risk can be based on any suitable information and/or data. As illustrated by the encircled number one, for example, the mobile payment application 112 may send information 202 about the credential 120 to the first-party service provider server(s) 102, and the first-party service provider server(s) 102 may determine a level of risk associated with the credential 120 based at least in part on the information 202. In other examples, the decision-maker (e.g., the first-party service provider server(s) 102, the mobile payment application 112, etc.) may already have access to the information (e.g., the credential information 202) used to determine the level of risk. Accordingly, the determination of risk can be made without having to provision the credential 120 itself to the first-party service provider 102, and, in some cases, without having to send credential information 202 (e.g., from the mobile payment application 112 to the first-party service provider server(s) 102 over the network(s) 116). The credential information 202 may represent, or include, a type of credential, services and/or service providers with which the credential 120 is used to authenticate the user and/or the mobile payment application 112, and/or any other suitable information. In some examples, the credential information 202 may represent, or include, a number of services and/or a number of service providers with which the credential 120 is used for authenticating the user and/or the mobile payment application 112. For example, the credential 120 may be used for authenticating with one, two, three, or possibly more than three services and/or service providers. Accordingly, the number of services and/or the number of service providers can be compared to a threshold to determine a level of risk. In an example where a credential 120 is associated with a level of risk that satisfies (e.g., meets or exceeds, or strictly exceeds) a threshold (e.g., because the credential 120 is used for authenticating with multiple (e.g., two or more) service providers and is thus more sensitive than other credentials that are not used for authenticating with multiple service providers), the service provider server(s) 102 can determine that the credential 120 is to be stored locally on the user computing device 114 and the mobile payment application 112 is to send the credential 120 to the third-party service provider server(s) 118 (without sending the credential 120 to the first-party service provider server(s) 102), as illustrated in FIG. 1. In an example where a credential 120 is associated with a level of risk that does not satisfy (e.g., is equal to or less than, or strictly less than) a threshold (e.g., because the credential 120 is not used for authenticating with multiple service providers and is therefore less sensitive), the service provider server(s) 102 can determine that the credential 120 can be provided by the mobile payment application 112 to the first-party service provider server(s) 102, and can be sent by the first-party service provider server(s) 102 to the third-party service provider server(s) 118, as illustrated by the encircled number two in FIG. 2.

In the latter example, as illustrated in FIG. 2, a session can be established between the first-party service provider server(s) 102 and the third-party service provider server(s) 118. Via the established session, data, such as payroll data 124, can be provided by the third-party service provider server(s) 118 to the first-party service provider server(s) 102 directly (without sending the data to the mobile payment application 112), as illustrated by the encircled number three in FIG. 2. In some examples, the session can be established (e.g., between the service provider server(s) 102 and the third-party service provider server(s) 118) for a period of time, until an event occurs (e.g., a predetermined number of data transmissions, a predetermined amount of data transmitted, etc.), or the like. In some examples, the data can be accessed via one or more APIs, a scraping component(s), and/or the like. In some examples, the component(s) used for establishing the session and facilitating data exchange between the service provider server(s) 102 and the third-party service provider server(s) 118 can be determined by the service provider server(s) 102, based at least in part on data associated with the third-party service provider.

In some examples, the third-party service provider server(s) 118 can send all of the data associated with the user account to which the credential 120 corresponds to the service provider server(s) 102. In some examples, the third-party service provider server(s) 118 can send a portion of the data associated with the user account to which the credential 120 corresponds to the service provider server(s) 102. In some examples, the portion can be selected by the user. In some examples, the portion can be in response to a request for particular data made by the service provider server(s) 102. In some examples, the format of the data received by the service provider server(s) 102 can be based on the components used in establishing the session between the service provider server(s) 102 and the third-party service provider server(s) 118.

The processes described herein are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is an example signal flow diagram illustrating a technique for accessing third-party service provider data without having to provide a credential(s) to a first-party service provider server(s) and/or other third-party service provider server(s). At 300, a mobile payment application 112 executing on a user computing device 114 may receive a request to access data (e.g., payroll data 124) associated with a user account of a user. The request received at 300 may be based at least in part on user input received via the mobile payment application 112, such as a user selection, via a user interface of the mobile payment application 112, of an interactive element to “show my payroll data.” In other examples, the request may be received at 300 from another mobile application executing on the user computing device 114 and/or from an external computing device (e.g., from the first-party service provider server(s) 102).

At 302, the mobile payment application 112 may send, to the first-party service provider server(s) 102, and based on the request to access data (e.g., payroll data 124), a request for service providers (e.g., payroll service providers). In some examples, the request sent at 302 may include a user identifier of a user who is logged into the mobile payment application 112, data indicating an interactive element(s) selected by the user, etc. In some examples, the user may be asked to provide identifying information as part of the request for service providers sent at 302, such as a username, a fingerprint, or any other suitable mechanism for identifying the user.

At 304, the first-party service provider server(s) 102, in response to receiving the request from the mobile payment application 112, may send (e.g., return) a list of service providers (e.g., one or more payroll service providers, which may include third party payroll service providers) to the mobile payment application 112. In some examples, the first-party service provider server(s) 102 may use the identifier of the user (e.g., a user identifier included in the request) to lookup the service providers (e.g., payroll service providers) that are associated with the user identifier. For example, the user may have previously setup a user profile with the first-party service provider, and in doing so, the user may have specified service providers (e.g., third party payroll service providers) with which the user has a registered user account(s), and the user may have input data to link the mobile payment application 112 to the systems of those third-party service providers.

At 306, the mobile payment application 112 may receive a selection of a service provider (e.g., a payroll service provider) from the returned list of service providers (e.g., payroll service providers). For example, a user interface of the mobile payment application 112 may present the list of service providers (e.g., payroll service providers) on a display of the user computing device 114, and the user may provide user input (e.g., by touching the display) to select a service provider (e.g., a payroll service provider) from the list.

At 308, in response to the selection of the service provider, the mobile payment application 112 may initiate (e.g., begin) an authentication process for the selected service provider (e.g., payroll service provider). The initiation of the authentication process may involve the mobile payment application 112 sending a request to the first-party service provider server(s) 102 indicative of the selected payroll service provider, the request representing a request for authenticating with the selected service provider (e.g., payroll service provider). The initiation of the authentication process at 308 may cause a first loop 310(1) to be executed until the authentication is complete.

During the execution of the first loop 310(1), the first-party service provider server(s) 102 may, at 312, send an instruction(s) to the mobile payment application 112 to execute, and/or proceed to, the next authentication instruction step for the selected service provider (e.g., payroll service provider). In some examples, this instruction(s) received at 312 by the mobile payment application 112 may serve as an acknowledgement that the first-party service provider server(s) 102 received the mobile payment application's request for authenticating with the selected service provider (e.g., payroll service provider). In some examples, the instruction(s) received at 312 may instruct the mobile payment application 112 to load a login page associated with the third-party service provider. In some examples, the first-party service provider server(s) 102 may craft instructions (e.g., details of authentication) and may send those instructions to the mobile payment application 112 at 312. Accordingly, the mobile payment application 112 may receive details of authentication (or authentication details) from the first-party service provider server(s) 102 at 312, in some examples. The details of authentication may include and/or specify, for example, one or more cookies or other text files that are to be used to authenticate requests later in the session, which credential 120 (among multiple available credentials) to provide to a third-party service provider server(s), a format in which to provide the credential 120, a type of encryption to use for providing the credential 120, additional data to provide along with the credential 120, a protocol to use for providing the credential 120, a type of authentication to implement with the third-party service provider, such as multifactor authentication (MFA).

In some examples, a communication 314 occurs between the first-party service provider server(s) 102 and the third-party service provider server(s) 118 associated with the selected service provider (e.g., payroll service provider) to facilitate the authentication during the first loop 310(1). This communication 314 may occur at any suitable time, such as prior to the receipt of the request at 300, in response to the receipt of the request at 300, in response to the initiation of the authentication process at 308, in response to sending the instruction(s) (e.g., authentication details) at 312, or the like. The purpose of the communication 314 between the first-party service provider server(s) 102 and the third-party service provider server(s) 118 may be to communicate or share the authentication details (e.g., authentication data) that the first-party service provider server(s) 102 has included, or is going to include, in the instruction(s) sent to the mobile payment application 112 at 312. In this manner, the third-party service provider server(s) 102 knows how, and is therefore able, to authenticate the user and/or the mobile payment application 112 based on the details of authentication. In other words, the first-party service provider server(s) 102 and the third-party service provider server(s) 118 may utilize the communication 314 (e.g., shared authentication data) to coordinate in regard to the details of authentication that are used to authenticate the user and/or the mobile payment application 112 during execution of the first loop 310(1).

At 316, during the execution of the first loop 310(1), and, in some examples, based on the instructions (e.g., details of authentication) received from the first-party service provider server(s) 102 at 312, the mobile payment application 112 may execute the next authentication instruction step for the selected service provider (e.g., payroll service provider). In the example of FIG. 3, the next authentication instruction step may involve the mobile payment application 112 displaying a login page associated with the third-party service provider (e.g., displaying the login page in a webview), and waiting for the cookie(s) received in the instruction(s) at 312 to be set. When the cookie(s) (or other text file(s)) have been set, the mobile payment application 112 may extract the cookie(s) (or other text file(s)), hide the webview, and send a request to the first-party service provider server(s) 102 for the next step of the first loop 310(1). In some examples, the next authentication instruction step may involve the mobile payment application 112 sending a credential(s) 120 to the third-party service provider server(s) 118 associated with the selected service provider (e.g., payroll service provider). The credential(s) 120 sent at 316 may be associated with a user account that is associated with the user of the user computing device 114. This user account may also be associated with the selected service provider (e.g., payroll service provider). In some examples, the credential(s) 120 is received via a user interface presented by the mobile payment application 112 (e.g., the user may provide user input via the user interface of the mobile payment application 112 to enter the credential). In other examples, the credential(s) may be retrieved by the mobile payment application 112 from local memory of the user computing device 114. In some examples, based on the instructions (e.g., details of authentication) received from the first-party service provider server(s) 102 at 312, the mobile payment application 112 may send a particular credential 120 specified in the authentication details (e.g., a particular credential 120 among multiple credentials) to the third-party service provider server(s) 118 at 316, may send the credential 120 in a particular format specified in the authentication details (e.g., a particular format among multiple formats) at 316, may send the credential 120 using a particular type of encryption specified in the authentication details (e.g., a particular type of encryption among multiple types of encryption) at 316, may send additional data specified in the authentication details (e.g., payment related security data) along with the credential 120 at 316, may send the credential 120 using a particular protocol specified in the authentication details (e.g., a particular protocol among multiple protocols) at 316, and/or may send the credential 120 with an indication of a particular type of authentication to implement specified in the authentication details (e.g., a particular type of authentication among multiple types of authentication), or the like.

The third-party service provider server(s) 118 may use an authentication component to authenticate the user and/or the mobile payment application 112 based on the execution of the authentication instruction step at 316. In some examples, the authentication component associated with the third-party service provider server(s) 118 authenticates based on the details of authentication received from the first-party service provider server(s) 102 in the communication 314. For example, the authentication component associated with the third-party service provider server(s) 118 may authenticate the user and/or the mobile payment application 112 based on additional data (e.g., payment related security data) received from the mobile payment application 112 along with the credential at 316, as instructed by the first-party service provider server(s) 102 in the instruction(s) sent at 312. If the user and/or mobile payment application 112 is authenticated, the third-party service provider server(s) may send an indication of a successful authentication to the mobile payment application 112 at 318. In the event of a failed authentication, a number of retries may occur, and if unsuccessful after the number of retries, the mobile payment application 112 may be prevented from fetching any data (e.g., payroll data 124) from the third-party service provider server(s) 118. In the example of FIG. 3, however, the authentication is successful, and the first loop 310(1) terminates with a successful authentication.

At 320, in response to a successful authentication with the third-party service provider server(s) 118, the mobile payment application 112 may initiate (e.g., begin) fetching data (e.g., payroll data 124) associated with the selected service provider (e.g., payroll service provider). The initiation of the data fetching at 320 may involve the mobile payment application 112 sending a request to the third-party service provider server(s) 118 to establish a session between the mobile payment application 112 and the third-party service provider server(s) 118 for fetching data (e.g., payroll data) associated with the selected service provider (e.g., payroll service provider). In some examples, the initiation of the data fetching at 320 may cause a second loop 310(2) to be executed until the data fetching is complete.

In some examples, execution of the second loop 310(2) involves establishing a session between the mobile payment application 112 and the third-party service provider server(s) 118. During the execution of the second loop 310(2), the first-party service provider server(s) 102 may, at 322, send an instruction(s) to the mobile payment application 112 to execute, and/or proceed to, the next data step (e.g., the next payroll data step) for the selected service provider (e.g., payroll service provider). Accordingly, the mobile payment application 112 may receive the instruction(s) from the first-party service provider server(s) 102 at 322. This instruction(s) received by the mobile payment application 112 may serve as an acknowledgement that the first-party service provider server(s) 102 received the mobile payment application's request for establishing the session to fetch the data (e.g., payroll data 124) associated with the selected service provider (e.g., payroll service provider). In some examples, the instruction(s) received at 322 may instruct the mobile payment application 112 to send a request (e.g., a GET request) to the third-party service provider server(s) 118 for an Employee Summary page or data associated therewith, for a Direct Deposit page or data associated therewith, for a Pay History page or data associated therewith, for a paystub(s) or data associated therewith, or the like. In some examples, the first-party service provider server(s) 102 may craft instructions (e.g., instructions to obtain specific data) and may send those instructions to the mobile payment application 112 at 322. The instructions to obtain specific data may include, for example, instructions to obtain data (e.g., payroll data 124) from a particular time-frame (e.g., from a start date to an end date), instructions to obtain data (e.g., payroll data 124) in a particular format, instructions to obtain data (e.g., payroll data 124) using a particular type of encryption, instructions to use a particular protocol for obtaining the data (e.g., payroll data 124), or the like. In some examples, the details of the data fetching provided in the instruction(s) received at 322 may be based on the type of user computing device 114, the type of mobile payment application 112, the type of transaction (e.g., payroll data fetching, as compared to fetching other types of data), or other such variables.

In some examples, the communication 314 between the first-party service provider server(s) 102 and the third-party service provider server(s) 118 associated with the selected service provider (e.g., payroll service provider) may facilitate the data fetching during the second loop 310(2). This communication 314 may occur at any suitable time, such as prior to the receipt of the request at 300, in response to the receipt of the request at 300, in response to the initiation of the authentication process at 308, in response to the initiation of the data fetching at 320, in response to the instruction(s) received at 322, or the like. The purpose of the communication 314 between the first-party service provider server(s) 102 and the third-party service provider server(s) 118 may be to communicate details of the data fetching that the first-party service provider server(s) 102 has included, or will include, in the instruction(s) sent to the mobile payment application 112 at 322. In this manner, the third-party service provider server(s) 102 knows how, and is therefore able, to fetch the data for the mobile payment application 112 based on the details of data fetching sent to the mobile payment application 112 at 322. In other words, the first-party service provider server(s) 102 and the third-party service provider server(s) 118 may utilize the communication 314 to coordinate in regard to the details of data fetching that are used to fetch data (e.g., payroll data 124) during execution of the second loop 310(2).

At 324, the mobile payment application 112 may fetch data (e.g., payroll data 124) from the third-party service provider server(s) 118. For example, the fetching at 324 may be a request for data (e.g., payroll data 124) sent by the mobile payment application 112 to the third-party service provider server(s) 118. In some examples, such a data request may conform to the instruction(s) that the mobile payment application 112 received from the first-party service provider server(s) 102 at 322. For example, the mobile payment application 112 may send a request to the third-party service provider server(s) 118, for example, using a HTTP client, attach the cookie(s) (or other text file(s)) extracted from the webview from the first loop 310(1) to prove that the user and/or the mobile payment application 112 has authenticated. In some examples, the mobile payment application 112 may request data from a particular time-frame (e.g., from a start date to an end date), may request data (e.g., payroll data 124) in a particular format, may request data (e.g., payroll data 124) using a particular type of encryption, may request data using a particular protocol, or the like.

At 326, the mobile payment application 112 may receive, via the established session, data (e.g., payroll data 124) from the third-party service provider server(s) 118. In provisioning the data (e.g., payroll data 124) to the mobile payment application 112 following a successful authentication, the third-party service provider server(s) 118 may conform to the specific instructions that the mobile payment application 112 received from the first-party service provider server(s) 102 at 322, which may have been communicated to the third-party service provider server(s) 118 in the communication 314. For example, the mobile payment application 112 may receive the data (e.g., payroll data 124) from a particular time-frame (e.g., from a start date to an end date), may receive the data (e.g., payroll data 124) in a particular format, may receive the data (e.g., payroll data 124) using a particular type of encryption, may receive the data using a particular protocol, or the like

At 328, the mobile payment application 112 may send (e.g., forward) at least a portion of the fetched data (e.g., payroll data 124) to the first-party service provider server(s) 102. This forwarding of at least the portion of the fetched data may be performed via the established session, which may be represented in FIG. 3 as part of the execution of the second loop 310(2). Notably, the data (e.g., payroll data 124) is fetched and forwarded to the first-party service provider server(s) 102 without having provided the credential(s) 120 to the first-party service provider server(s) 102. In this manner, the first-party service provider server(s) 102 can still access the data (e.g., payroll data 124), even without having been provided the credential(s) 120 that is required to access the data. This addresses security issues that arise with existing scraping technologies where the first-party service provider server(s) 102 would otherwise receive, store, and/or use the credential(s) 120 in order to access the third-party service provider data. In some examples, the mobile payment application 112 may forward, to the first-party service provider server(s) 102 at 328, a response (e.g., an HTML response) received from the third-party service provider server(s) 118.

At 330, the first-party service provider server(s) 102 may process the received data (e.g., payroll data 124). For example, one or more components (e.g., the banking component 104, the payroll component 106, the payment component 108) may process the data (e.g., payroll data 124) to enable one or more services. In some examples, the first-party service provider server(s) 102 may parse a response (e.g., an HTML response) forwarded from the mobile payment application 112 to extract information, such as a name, employee number, email address, location, supervisor, direct deposit accounts/allocations, links to a number of most recent paystubs. In some examples, paystubs are processed by extracting start/end date, hours worked, etc. In some examples, the payroll data 124 can be processed at 330 and used to indicate (e.g., via a user interface of the mobile payment application 112) a timing or an amount of a payroll payment, an account or accounts to which the payroll payment is to be made, and/or the like. In such an example, the banking component 104, the payroll component 106, and/or the payment component 108 can utilize such data in making determinations such as lending-related decisions, withdrawal-related decisions, and/or the like. For example, payroll data 124 may indicate an income of the user, and a loan can be offered to the user via the mobile payment application 112 (e.g., to purchase an item, to make a payment to another user, etc.) based on projected wages that are to be earned by the user based on past earned wages. In an illustrative example, a user may use the mobile payment application 112 to purchase an item available for sale from a merchant, and the payment component 108 may offer the user a buy now, pay later loan as a payment option. In this example, the determination to offer the loan and/or the terms of the loan may be based at least in part on the payroll data 124 forwarded to the first-party service provider server(s) 102 via the mobile payment application 112 and processed at 330. In the example of FIG. 3, the first-party service provider server(s) 102 sends the processed data (e.g., payroll data 124) to the mobile payment application 112 at 332 to cause the mobile payment application 112 to display the processed data (e.g., payroll data 124) and/or information relating thereto via a user interface of the mobile payment application 112 at 334. For example, the user, at 334, may be able to view the data (e.g., payroll data 124), such as a timing or an amount of a payroll payment, an account or accounts to which the payroll payment is to be made, and/or the like.

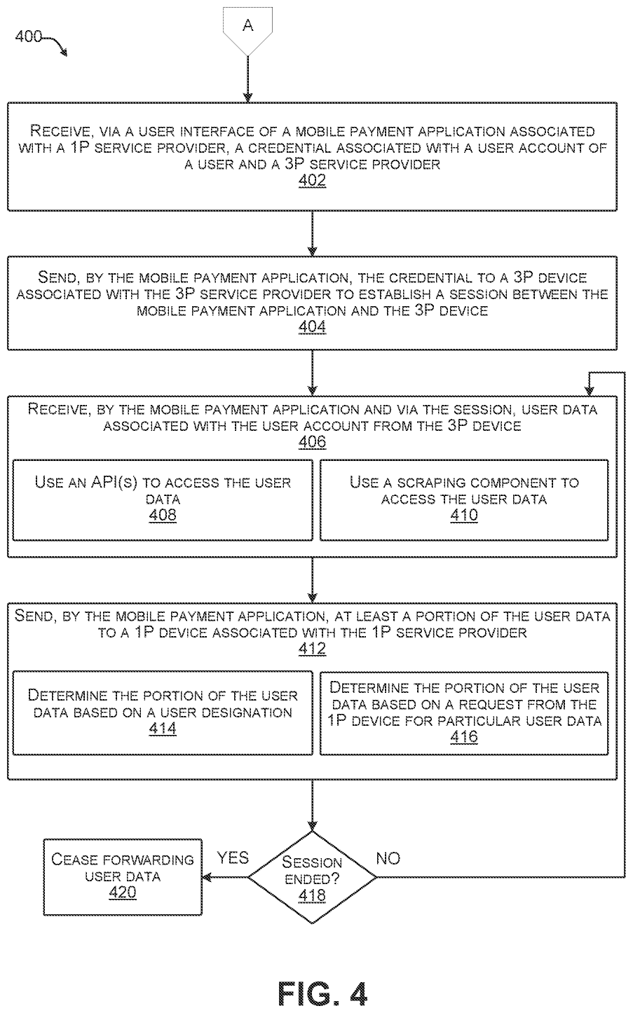

FIG. 4 is an example process 400 for accessing third-party service provider data without having to provide credentials to a first-party service provider server(s) 102 and/or other third-party service provider server(s), according to an implementation of the present subject matter. The process 400 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 400. The process 400 can be implemented by a system including one or more processors and memory storing computer-executable instructions to cause the one or more processors to perform the process 400. In some examples, the process 400 can be implemented by a processing device(s), such as the user computing device 114. For discussion purposes, the process 400 is described with reference to the previous figures.

At 402, a credential(s) 120 is received via a user interface 122 presented by a mobile payment application 112. In some examples, a user computing device 114 (e.g., a processor(s) thereof, and/or the mobile payment application 112 executing thereon) may receive the credential(s) 120 at block 402. The mobile payment application 112 may be associated with a service provider, such as a first-party service provider. The credential(s) 120 may be associated with a user account of a user and a third-party service provider (e.g., a third-party payroll service provider). Accordingly, the credential(s) 120 may be unknown to the first-party service provider associated with the mobile payment application 112 executing on the user computing device 114. Moreover, the credential(s) 120 received at block 402 may include a password, a security key, log-in data, a passcode, or a SSO usable by the user to access services (e.g., payroll services) associated with at least the third-party service provider (e.g., a payroll service provider).

At 404, the credential(s) 120 is sent to at least one computing device of the third-party service provider, such as a third-party service provider server(s) 118. In some examples, the user computing device 114 (e.g., a processor(s) thereof, and/or the mobile payment application 112 executing thereon) may send the credential at block 404. In some examples, a session is established between the mobile payment application 112 and the at least one computing device of the third-party service provider (e.g., the third-party service provider server(s) 118) based at least in part on the sending of the credential(s) 120 at block 404.

At 406, user data is received, via the session, from the at least one computing device of the third-party service provider (e.g., the third-party service provider server(s) 118). In some examples, the user computing device 114 (e.g., a processor(s) thereof, and/or the mobile payment application 112 executing thereon) may receive the user data at block 406. The user data received at block 406 may be associated with the user account of the user (i.e., the user account that is associated with the third-party service provider). The user data received at block 406 can be any suitable type of data described herein, such as payroll data 124.

At sub-block 408, in some examples, one or more APIs are used to access the user data that is received at block 406. For example, the mobile payment application 112 may utilize an API(s) to access, or otherwise receive, the user data from the at least one computing device of the third-party service provider (e.g., the third-party service provider server(s) 118). Accordingly, the user data may be accessible via the session using one or more APIs, in some examples.

At sub-block 410, in some examples, one or more scraping components are used to access the user data that is received at block 406. For example, the mobile payment application 112 may utilize a scraping component(s) to access, or otherwise receive (e.g., extract), the user data from the at least one computing device of the third-party service provider (e.g., the third-party service provider server(s) 118). Accordingly, the user data may be accessible via the session using one or more a scraping components, in some examples.

At 412, at least a portion of the user data is sent to at least one computing device of the service provider, such as a first-party service provider server(s) 102 associated with the first-party service provider. In some examples, the user computing device 114 (e.g., a processor(s) thereof, and/or the mobile payment application 112 executing thereon) may send at least the portion of the user data at block 412. Furthermore, at least the portion of the user data may be sent at block 412 without having provided the credential(s) 120 to the at least one computing device of the service provider (e.g., the first-party service provider server(s) 102).

At sub-block 414, in some examples, the portion of the user data sent at block 412 is determined based at least in part on a designation by the user. For example, the user may designate a subset(s) of payroll data 124 received via the session at block 406, such as by providing user input to the mobile payment application 112 (e.g., via selecting a subset(s) of the received payroll data 124 presented on a user interface of the mobile payment application 112). In some examples, the user may adjust settings of the mobile payment application 112 at any suitable time (e.g., at an earlier point in time) to designate certain types of data that the user wants to send to the computing device(s) of the service provider (e.g., the first-party service provider server(s) 102).

At sub-block 416, in some examples, the portion of the user data sent at block 412 is determined based at least in part on a request, from the at least one computing device of the service provider (e.g., the first-party service provider server(s) 102), for particular user data. For example, the at least one computing device of the service provider (e.g., the first-party service provider server(s) 102) may craft instructions (e.g., instructions to obtain specific data) and may send those instructions to the mobile payment application 112 at any suitable time prior to block 412, such as a time between performing the operations of blocks 404 and 406 of the process 400. The instructions to obtain specific data may include, for example, instructions to obtain data (e.g., payroll data 124) from a particular time-frame (e.g., from a start date to an end date), instructions to obtain data (e.g., payroll data 124) in a particular format, instructions to obtain a particular subset(s) of a type of data (e.g., payroll data 124), or the like. In some examples, the portion of the user data can be determined based at least in part on a type of data being requested, a source of the data, a use of the data, and/or the like.

At 418, in some examples, a determination is made as to whether the session has ended. As discussed herein, a session can be maintained for a period of time or until an occurrence of an event. Accordingly, the determination made at block 418 may include a determination as to whether the period of time has lapsed, or whether the event has occurred, causing the session to terminate. In some examples, the user computing device 114 (e.g., a processor(s) thereof, and/or the mobile payment application 112 executing thereon) may make the determination at block 418. In examples where a lapse of a period of time causes the session to end, the period of time may be predetermined and/or dynamically determined in real-time or near real-time based on one or more factors. In one example, all sessions for all users may be allotted the same, predetermined amount of time before the session ends. In other examples, a session duration may be based at least in part on the time of day, the day of the week, available network bandwidth, network latency, the type of data being accessed, the amount of data being retrieved and forwarded, a type of encryption being used to encrypt the data for transfer to the mobile payment application 112 (e.g., more secure encryption may allow for a longer session duration, whereas less secure encryption may warrant back-to-back sessions of shorter duration to transfer data, etc.), a geographic location of the user computing device 114, a type of network connection (e.g., wired, WiFi, cellular, satellite, etc.), and/or a combination thereof. In examples where the occurrence of an event causes the session to end, the event may occur when a predetermined number of data transmissions have been made, when a predetermined amount of data has been transmitted, when a network connection is lost, when network bandwidth decreases below a threshold, when network latency increases above a threshold, when the mobile payment application 112 is closed and/or moved to the background, when the user terminates the session via user input received via the mobile payment application 112, when a security component detects a security event (e.g., malware, a hack attempt, etc.), when an outage of either or both of the server(s) 102, 118 occurs, and/or a combination thereof. If the determination at block 418 is that the session has not ended (e.g., the period of time has not lapsed, or the event has not occurred), the process 400 may follow the NO route from block 418 to block 406 where updated user data is received from the at least one computing device of the third-party service provider (e.g., the third-party service provider server(s) 118), and blocks 406 to 418 may iterate while the session is maintained (e.g., until the session terminates). In other words, the mobile payment application 112 may continue to receive updated user data in an iterative fashion while the session is maintained. If the determination at block 418 is that the session has ended (e.g., the period of time has lapsed, or the event has occurred), the process 400 may follow the YES route from block 418 to block 420, where the user computing device 114 (e.g., a processor(s) thereof, and/or the mobile payment application 112 executing thereon) may cease forwarding (or sending) user data to the at least one computing device of the service provider (e.g., the first-party service provider server(s) 102).

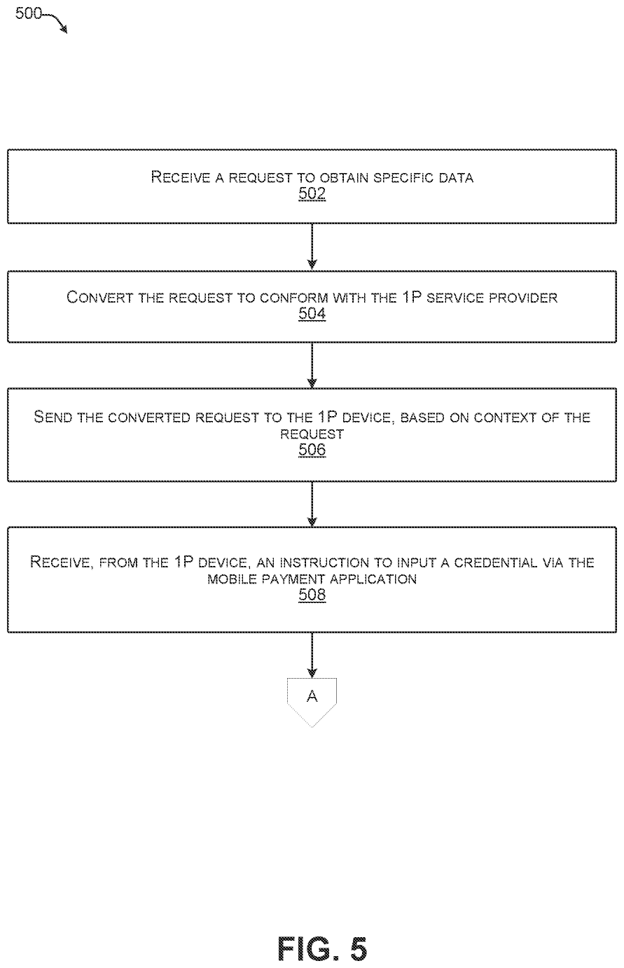

FIG. 5 is an example process 500 for initiating an authentication of a user and/or a mobile payment application based on a request to obtain specific data, according to an implementation of the present subject matter. The process 500 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 500. The process 500 can be implemented by a system including one or more processors and memory storing computer-executable instructions to cause the one or more processors to perform the process 500. In some examples, the process 500 can be implemented by a processing device(s), such as the user computing device 114. For discussion purposes, the process 500 is described with reference to the previous figures. Furthermore, as shown by the off-page reference “A” in FIGS. 4 and 5, the process 500 may precede the process 400, and hence, the process 400 may continue from block 508 of the process 500.

At 502, a request to obtain specific data is received. In some examples, the user computing device 114 (e.g., a processor(s) thereof, and/or the mobile payment application 112 executing thereon) may receive the request to obtain specific data at block 502. In some examples, the request received at 502 may be based at least in part on user input received via the mobile payment application 112, such as a user selection, via a user interface of the mobile payment application 112, of an interactive element (e.g., an interactive element to “show my payroll data”). In other examples, the request received at 502 may be received from another mobile application executing on the user computing device 114 and/or from an external computing device with respect to the user computing device 114.

At 504, the request is converted to conform with a service provider associated with the mobile payment application 112, such as the first-party service provider. In some examples, the user computing device 114 (e.g., a processor(s) thereof, and/or the mobile payment application 112 executing thereon) may convert the request at block 504. Converting the request at block 504 may involve converting the request from a first format to a second format, the second format conforming with the first-party service provider. Converting the request at block 504 may involve packaging data for the request in accordance with a particular protocol (e.g., data packets having a particular format).

At 506, the converted request to access specific data is sent to at least one computing device of the service provider (e.g., the first-party service provider server(s) 102), based on context of the request. In some examples, the user computing device 114 (e.g., a processor(s) thereof, and/or the mobile payment application 112 executing thereon) may send the converted request at block 506. In some examples, the context of the request may be a time of the request, an originator of the request, or any other suitable context. Accordingly, the request that is sent at block 506 may be based on the context by, for example, including the context in the request, and/or the request may be sent at block 506 based on the context if the context satisfies one or more criteria.

At 508, an instruction(s) to input a credential(s) 120 via the mobile payment application 112 is received from the at least one computing device of the service provider (e.g., the first-party service provider server(s) 102). The credential(s) 120 may be associated with a user account of a user and a third-party service provider and may be unknown to the first-party service provider server(s) 102. For example, the credential(s) 120 may be usable by the user to access services associated with the third-party service provider. As depicted by the off-page reference “A” in FIGS. 4 and 5, in response to receiving the instruction(s) at block 508, the credential(s) 120 may be received via the user interface of the mobile payment application 112 at block 402 of the process 400.

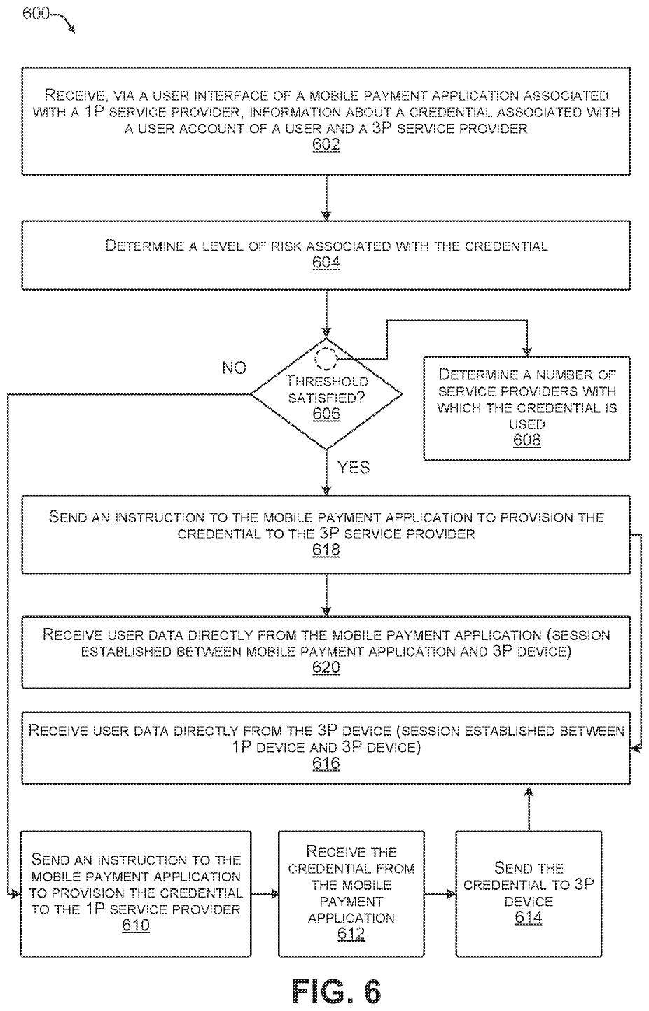

FIG. 6 is an example process 600 for dynamically determining whether to send a credential(s) 120 to a third-party service provider server(s) indirectly via a first-party service provider server(s) to access third-party service provider data, according to an implementation of the present subject matter. The process 600 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 600. The process 600 can be implemented by a system including one or more processors and memory storing computer-executable instructions to cause the one or more processors to perform the process 600. In some examples, the process 600 can be implemented by a processing device(s), such as at least one computing device of a service provider (e.g., the first-party service provider server(s) 102) and/or the user computing device 114. For discussion purposes, the process 600 is described with reference to the previous figures.

At 602, information 202 about a credential(s) 120 is received via a user interface 122 presented by a mobile payment application 112. In some examples, at least one computing device of a service provider (e.g., the first-party service provider server(s) 102, and/or a processor(s) thereof) may receive the credential information 202 at block 602 over a network(s) 116 from the mobile payment application 112. The mobile payment application 112 may be associated with the service provider, such as the first-party service provider. The credential(s) 120 may be associated with a user account of a user and a third-party service provider (e.g., a third-party payroll service provider). Accordingly, the credential(s) 120 may be unknown to the first-party service provider associated with the mobile payment application 112 executing on the user computing device 114. Moreover, the credential(s) 120 may include a password, a security key, log-in data, a passcode, or a SSO usable by the user to access services (e.g., payroll services) associated with at least the third-party service provider (e.g., a payroll service provider). In some examples, the credential information 202 received at block 602 may represent, or include, a type of credential, services and/or service providers with which the credential 120 is used to authenticate the user, or any other suitable information. In some examples, the credential information 202 may represent, or include, a number of services and/or a number of service providers with which the credential 120 is used for authenticating the user and/or the mobile payment application 112.

At 604, a level of risk associated with the credential(s) 120 is determined. In some examples, the at least one computing device of the service provider (e.g., the first-party service provider server(s) 102, and/or a processor(s) thereof) may determine the level of risk at block 604. In some examples, the level of risk is determined as a risk metric (e.g., a value, a score, a binary (risky, not risky) indication, etc.) at block 604. In some examples, the risk metric may relate to a probability of the credential(s) 120 being in a low risk class, a high risk class, or one or more intermediate risk classes. In some examples, a machine-trained model(s) (i.e., a trained machine-learning model(s)) may be used to determine the level of risk at block 604 based at least in part on the credential information 202 received at block 602 and/or based on data relating thereto. Such a machine-trained model(s) may be trained using a training dataset, which, in some examples, can include at least a portion of previously collected data associated with credentials that are, or have been, used to access third-party data. Machine learning can involve processing a set of examples (called “training data” or a “training dataset”) in order to train a machine learning model(s). A machine learning model(s), once trained, is a learned mechanism that can receive new data as input and estimate or predict a result as output. For example, a trained machine learning model can comprise a classifier that is tasked with classifying unknown input (e.g., an unknown image) as one of multiple class labels (e.g., labeling the image as a cat or a dog). In some cases, a trained machine learning model is configured to implement a multi-label classification task (e.g., labeling images as “cat,” “dog,” “duck,” “penguin,” and so on). Additionally, or alternatively, a trained machine learning model can be trained to infer a probability, or a set of probabilities, for a classification task based on unknown data received as input. In the context of the present disclosure, a trained machine-trained model(s) can receive information 202 about a credential(s) 120 and/or the credential 120 itself as unknown input, and may be tasked with outputting a risk metric (e.g., a value, a score, a binary (risky, not risky) indication, etc.) based on the input data. The training dataset that is used to train the machine learning model may include various types of data, including previously collected data associated with credentials used to access third-party data, such as login data, password strength data, security event data (e.g., hacking attempts, etc.), authentication procedure data (e.g., a type of authentication implemented in the past, such as MFA), user data associated with users who utilize credentials to access third-party data, such as transaction data associated with users, user interaction data associated with the users, third party data associated with the users, tenure data associated with the users, the tenure data indicating respective lengths of time the users has been registered users of a service(s) provided by the third-party service provider or the first-party service provider, demographic data associated with the users, contact data associated with the users, behavioral data associated with the users, financial data associated with the users, and/or user preference data associated with the users. In general, a training dataset for machine learning can include two components: features and labels. However, the training dataset used to train the machine learning model(s) may be unlabeled, in some embodiments. Accordingly, the machine learning model(s) may be trainable using any suitable learning technique, such as supervised learning, unsupervised learning, semi-supervised learning, reinforcement learning, and so on. The features included in the training dataset can be represented by a set of features, such as in the form of an n-dimensional feature vector of quantifiable information about an attribute of the training dataset. As part of the training process, weights may be set for machine learning. These weights may apply to a set of features included in the training data, as derived from historical data (e.g., previously collected user data). In some embodiments, the weights that are set during the training process may apply to parameters that are internal to the machine learning model(s) (e.g., weights for neurons in a hidden-layer of a neural network). These internal parameters of the machine learning model(s) may or may not map one-to-one with individual input features of the set of features. The weights can indicate the influence that any given feature or parameter has on the output of the trained machine learning model.

At 606, a determination as to whether the level of risk satisfies a threshold is made. In some examples, the at least one computing device of the service provider (e.g., the first-party service provider server(s) 102, and/or a processor(s) thereof) may determine whether the level of risk satisfies a threshold at block 606. In some examples, the determination of the level of risk at block 604 and/or the determination as to whether the level of risk satisfies a threshold at block 606 may include determining, at 608, a number of service providers and/or services with which the credential(s) 120 is used. For example, the credential(s) 120 may be used for authenticating with one, two, three, or more services and/or service providers. If, say, the threshold is set at two services and/or two service providers, the level of risk may satisfy the threshold at block 606 if the credential(s) 120 is usable for authenticating with at least two services and/or at least two service providers. If it is determined, at block 606, that the level of risk does not satisfy the threshold (e.g., because the credential 120 is not used for authenticating with multiple service providers and is therefore less sensitive), the process 600 may follow the NO route from block 606 to block 610.

At 610, an instruction(s) is sent to the mobile payment application 112 to provision the credential to the first-party service provider. In some examples, the at least one computing device of the service provider (e.g., the first-party service provider server(s) 102, and/or a processor(s) thereof) may send the instruction(s) at block 610.

At 612, the credential(s) 120 is received from the mobile payment application 112. In some examples, the at least one computing device of the service provider (e.g., the first-party service provider server(s) 102, and/or a processor(s) thereof) receives the credential(s) 120 at block 612.

At 614, the credential(s) 120 is sent (e.g., forwarded) to at least one computing device of the third-party service provider (e.g., the third-party service provider server(s) 118). In some examples, based at least in part on the sending of the credential(s) 120 to the at least one computing device of the third-party service provider (e.g., the third-party service provider server(s) 118) at block 614, a session is established between the at least one computing device of the service provider (e.g., the first-party service provider server(s) 102) and the at least one computing device of the third-party service provider (e.g., the third-party service provider server(s) 118).

At 616, user data is received from the at least one computing device of the third-party service provider (e.g., the third-party service provider server(s) 118). In some examples, the at least one computing device of the service provider (e.g., the first-party service provider server(s) 102, and/or a processor(s) thereof) receives the user data at block 616. The user data (e.g., payroll data 124) received at block 616 may be associated with the user account of the user. In some examples, the user data is received at block 616 via the established session between the at least one computing device of the service provider (e.g., the first-party service provider server(s) 102) and the at least one computing device of the third-party service provider (e.g., the third-party service provider server(s) 118).

If it is determined, at block 606, that the level of risk satisfies the threshold (e.g., because the credential 120 is used for authenticating with multiple service providers and is therefore more sensitive), the process 600 may follow the YES route from block 606 to block 618. At 618, an instruction(s) is sent to the mobile payment application 112 to provision the credential to the third-party service provider. In some examples, the at least one computing device of the service provider (e.g., the first-party service provider server(s) 102, and/or a processor(s) thereof) sends the instruction(s) at block 618. In some examples, based at least in part on sending the instruction(s) at block 618, the mobile payment application 112 sends the credential(s) 120 to at least one computing device of the third-party service provider (e.g., the third-party service provider server(s) 118). In some examples, based at least in part on the sending of the credential(s) 120 from the mobile payment application 112 to the at least one computing device of the third-party service provider (e.g., the third-party service provider server(s) 118), a session is established between the mobile payment application 112 and the at least one computing device of the third-party service provider (e.g., the third-party service provider server(s) 118).

At 620, user data is received from the mobile payment application 112. In some examples, the at least one computing device of the service provider (e.g., the first-party service provider server(s) 102, and/or a processor(s) thereof) receives the user data at block 620. The user data (e.g., payroll data 124) received at block 620 may be associated with the user account of the user. In some examples, the user data is received at block 620 via the established session between the mobile payment application 112 and the at least one computing device of the third-party service provider (e.g., the third-party service provider server(s) 118). In some examples, the user data is first received by the mobile payment application 112 from the at least one computing device of the third-party service provider (e.g., the third-party service provider server(s) 118) before the user data is received at block 620.

It is to be appreciated that the user data (e.g., payroll data 124) received at block 616 or block 620 of the process 600 may be accessible via the established session using one or more APIs, in some examples. In other examples, the user data (e.g., payroll data 124) received at block 616 or block 620 of the process 600 may be accessible via the established session using one or more scraping components. In some examples, the at least one computing device of the service provider (e.g., the first-party service provider server(s) 102, and/or a processor(s) thereof) may send, to the mobile payment application 112, a request for particular user data. This may occur at block 618 or at block 610 of the process 600. In this scenario, the user data received at block 616 or block 620 may be, or include, a portion of the user data that corresponds to the particular user data requested. It is also to be appreciated that the session established during the process 600 for fetching the user data may be maintained for a period of time or until an occurrence of an event, and that updated user data may be received, via the session, while the session is maintained, similar to the description of the process 400 of FIG. 4, above. In some examples, as indicated by the arrow from block 618 to block 616, after the service provider (e.g., the first-party service provider server(s) 102, and/or a processor(s) thereof) sends the instruction(s) to the mobile payment application 112 at block 618, the at least one computing device of the service provider (e.g., the first-party service provider server(s) 102, and/or a processor(s) thereof) may receive the user data from the at least one computing device of the third-party service provider (e.g., the third-party service provider server(s) 118) at block 616. That is, notwithstanding the level of risk satisfying the threshold at block 606, the first-party service provider server(s) 102 may receive the user data at block 616 via an established session between the first-party service provider server(s) 102 and the third-party service provider server(s) 118.

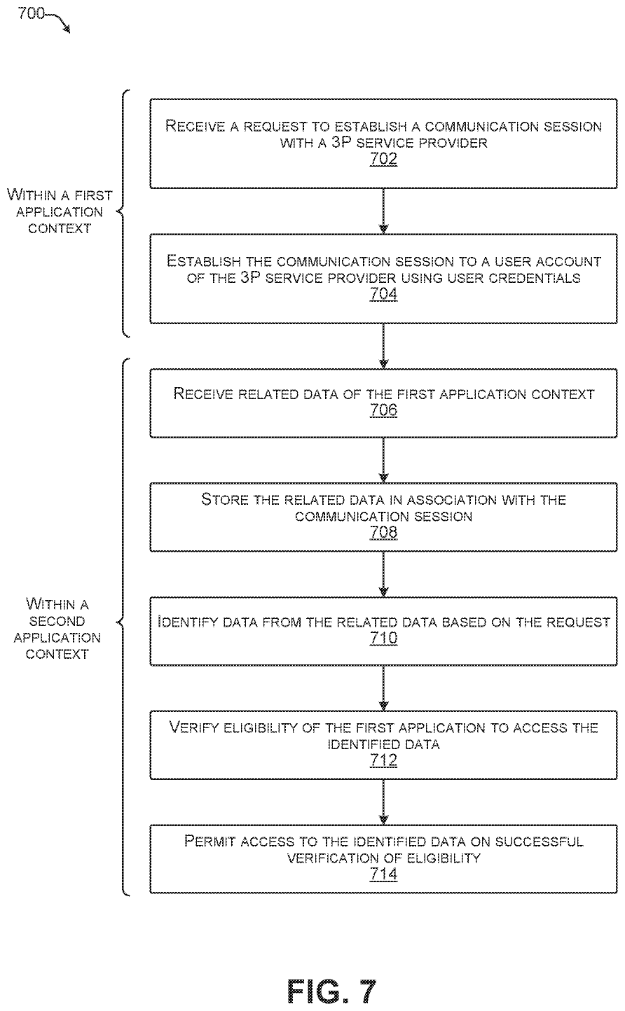

FIG. 7 is an example process 700 for verifying eligibility of a mobile application to access third-party service provider data, according to an implementation of the present subject matter. The process 700 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 700. The process 700 can be implemented by a system including one or more processors and memory storing computer-executable instructions to cause the one or more processors to perform the process 700. In some examples, the process 700 can be implemented by a processing device(s), such as the user computing device 114. For discussion purposes, the process 700 is described with reference to the previous figures.

At 702, within a first application context, a request to establish a communication session with a third-party service provider is received. In some examples, the user computing device 114 (e.g., a processor(s) thereof, and/or the mobile payment application 112 executing thereon) may receive the request at block 702. In some examples, the request may be received at block 702 from at least one computing device of a service provider (e.g., the first-party service provider server(s) 102). In some examples, the first application context may be associated with the mobile payment application 112 executing on the user computing device 114.

At 704, within the first application context, the communication session is established to (or in association with) a user account of the third-party service provider using one or more user credentials 120. In some examples, the user computing device 114 (e.g., a processor(s) thereof, and/or the mobile payment application 112 executing thereon) may establish the communication session at block 704. In some examples, the credential(s) 120 used to establish the communication session at block 704 may be stored locally on the user computing device 114 and may be unknown to the first-party service provider. Accordingly, the communication session may be established by the mobile payment application 112 on behalf of the first-party service provider, without provisioning the credential(s) 120 to the first-party service provider.

At 706, within a second application context, related data of the first application context is received. In some examples, the user computing device 114 (e.g., a processor(s) thereof, and/or a third-party service provider application executing thereon) may receive the related data at block 706. In some examples, the second application context may be associated with the third-party service provider application (e.g., a mobile payroll application) executing on the user computing device 114. This third-party service provider application may be serviced by the third-party service provider who maintains the data that is being fetched by the user computing device 114 on behalf of the first-party service provider. In some examples, although the related data (e.g., payroll data 124) is received at block 706, the received data may be inaccessible to, and/or unreadable by, the mobile payment application 112 unless and until the eligibility of the mobile payment application 112 to access the received data is verified. For example, the mobile payment application 112 may not possess a private key to decrypt the related data, if the related data is received as encrypted data at block 706.

At 708, within the second application context, the related data received at block 706 is stored in association with the communication session. In some examples, the user computing device 114 (e.g., a processor(s) thereof, and/or a third-party service provider application executing thereon) may store the related data at block 708. In some examples, an identifier of the communication may be stored in association with the related data at block 708 to associate the related data with the communication session. In some examples, the related data is stored locally on the user computing device 114.

At 710, within the second application context, data from the related data is identified based at least in part on the request received at block 702, such as in response to the request. In some examples, the user computing device 114 (e.g., a processor(s) thereof, and/or a third-party service provider application executing thereon) may identify the data at block 710 as identified data. In some examples, the request received at block 702 may pertain to a request for specific data, and the identified data corresponds to the specific data requested.

At 712, within the second application context, eligibility of a first application (e.g., the mobile payment application 112) to access the identified data is verified. In some examples, the user computing device 114 (e.g., a processor(s) thereof, and/or a third-party service provider application executing thereon) may verify the eligibility of the first application (e.g., the mobile payment application 112) at block 712. Eligibility may be verified based on records maintained by the third-party service provider in coordination with the first-party service provider.

At 714, within the second application context, access to the identified data is permitted on successful verification of eligibility. In some examples, the user computing device 114 (e.g., a processor(s) thereof, and/or a third-party service provider application executing thereon) may permit access to the identified data at block 714. In some examples, the access permitted at block 714 is access by the first application (e.g., the mobile payment application 112).

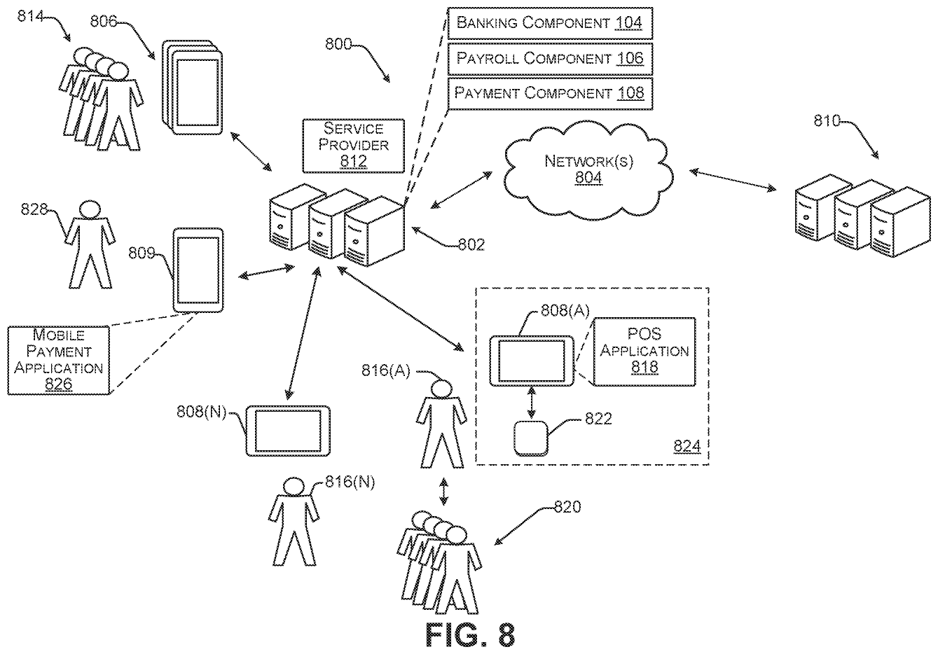

FIG. 8 illustrates an example environment 800. The environment 800 includes server computing device(s) 802 that can communicate over a network 804 with user devices 806 (which, in some examples can be merchant devices 808 (individually, 808(A)-808(N), payor/payee devices such as payor/payee device 809)) and/or server computing device(s) 810 associated with third-party service provider(s). The server computing device(s) 802 can be associated with a service provider 812 that can provide one or more services for the benefit of users 814, as described below. Actions attributed to the service provider 812 can be performed by the server computing device(s) 802.

For example, the server(s) 802 may be the same as or similar to the server(s) 102 introduced in FIG. 1, and the server(s) 802 may implement the banking component 104, the payroll component 106, and/or the payment component 108. Furthermore, the network(s) 804 may be the same as or similar to the network(s) 116 introduced in FIG. 1.

The environment 800 can include a plurality of user devices 806, as described above. Each one of the plurality of user devices 806 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. The user devices 806 (and in some examples, the user devices 808, 809) may be the same as or similar to the user computing device 114 introduced in FIG. 1. In some examples, individual ones of the user devices can be operable by users 814. The users 814 can be referred to as customers, buyers, merchants, sellers, borrowers, employees, employers, payors, payees, couriers and so on. The users 814 can interact with the user devices 806 via user interfaces presented via the user devices 806. In at least one example, a user interface can be presented via a web browser, or the like. In other examples, a user interface can be presented via an application, such as a mobile application or desktop application, which can be provided by the service provider 812 or which can be an otherwise dedicated application. In some examples, individual of the user devices 806 can have an instance or versioned instance of an application, which can be downloaded from an application store, for example, which can present the user interface(s) described herein. In at least one example, a user 814 can interact with the user interface via touch input, spoken input, or any other type of input.

As described above, in at least one example, the users 814 can include merchants 816 (individually, 816(A)-816(N)). In an example, the merchants 816 can operate respective merchant devices 808, which can be user devices 806 configured for use by merchants 816. For the purpose of this discussion, a “merchant” can be any entity that offers items (e.g., goods or services) for purchase or other means of acquisition (e.g., rent, borrow, barter, etc.). The merchants 816 can offer items for purchase or other means of acquisition via brick-and-mortar stores, mobile stores (e.g., pop-up shops, food trucks, etc.), online stores, combinations of the foregoing, and so forth. In some examples, at least some of the merchants 816 can be associated with a same entity but can have different merchant locations and/or can have franchise/franchisee relationships. In additional or alternative examples, the merchants 816 can be different merchants. That is, in at least one example, the merchant 816(A) is a different merchant than the merchant 816(N).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 808 can have an instance of a POS application 818 stored thereon. The POS application 818 can configure the merchant device 808 as a POS terminal, which enables the merchant 816(A) to interact with one or more customers 820. As described above, the users 814 can include customers, such as the customers 820 shown as interacting with the merchant 816(A). For the purpose of this discussion, a “customer” can be any entity that acquires items from merchants. While four customers 820 are illustrated in FIG. 8, any number of customers 820 can interact with the merchants 816. Further, while FIG. 8 illustrates the customers 820 interacting with the merchant 816(A), the customers 820 can interact with any of the merchants 816.

In at least one example, interactions between the customers 820 and the merchants 816 that involve the exchange of funds (from the customers 820) for items (from the merchants 816) can be referred to as “POS transactions” and/or “transactions.” In at least one example, the POS application 818 can determine transaction data associated with the POS transactions. Transaction data can include payment information, which can be obtained from a reader device 822 associated with the merchant device 808(A), user authentication data, purchase amount information, point-of-purchase information (e.g., item(s) purchased, date of purchase, time of purchase, etc.), etc. The POS application 818 can send transaction data to the server computing device(s) 802. Furthermore, the POS application 818 can present a UI to enable the merchant 816(A) to interact with the POS application 818 and/or the service provider 812 via the POS application 818.

In at least one example, the merchant device 808(A) can be a special-purpose computing device configured as a POS terminal (via the execution of the POS application 818). In at least one example, the POS terminal may be connected to a reader device 822, which is capable of accepting a variety of payment instruments, such as credit cards, debit cards, gift cards, short-range communication based payment instruments, and the like, as described below. In at least one example, the reader device 822 can plug in to a port in the merchant device 808(A), such as a microphone port, a headphone port, an audio-jack, a data port, or other suitable port. In additional or alternative examples, the reader device 822 can be coupled to the merchant device 808(A) via another wired or wireless connection, such as via a Bluetooth®, BLE, and so on. Additional details are described below with reference to FIG. 7. In some examples, the reader device 822 can read information from alternative payment instruments including, but not limited to, wristbands and the like.

In some examples, the reader device 822 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 822, and communicate with the server computing device(s) 802, which can provide, among other services, a payment processing service. The server computing device(s) 802 associated with the service provider 812 can communicate with server computing device(s) 810, as described below. In this manner, the POS terminal and reader device 822 may collectively process transaction(s) between the merchants 816 and customers 820. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 822 of the POS system 824 are shown as separate devices, in additional or alternative examples, the POS terminal and the reader device 822 can be part of a single device. In some examples, the reader device 822 can have a display integrated therein for presenting information to the customers 820. In additional or alternative examples, the POS terminal can have a display integrated therein for presenting information to the customers 820. POS systems, such as the POS system 824, may be mobile, such that POS terminals and reader devices may process transactions in disparate locations across the world. POS systems can be used for processing card-present transactions and card-not-present (CNP) transactions, as described below.

A card-present transaction is a transaction where both a customer 820 and his or her payment instrument are physically present at the time of the transaction. Card-present transactions may be processed by swipes, dips, taps, or any other interaction between a physical payment instrument (e.g., a card), or otherwise present payment instrument, and a reader device 822 whereby the reader device 822 is able to obtain payment data from the payment instrument. A swipe is a card-present transaction where a customer 820 slides a card, or other payment instrument, having a magnetic strip through a reader device 822 that captures payment data contained in the magnetic strip. A dip is a card-present transaction where a customer 820 inserts a payment instrument having an embedded microchip (i.e., chip) into a reader device 822 first. The dipped payment instrument remains in the payment reader until the reader device 822 prompts the customer 820 to remove the card, or other payment instrument. While the payment instrument is in the reader device 822, the microchip can create a one-time code which is sent from the POS system 824 to the server computing device(s) 810 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 820 may tap or hover his or her payment instrument (e.g., card, electronic device such as a smart phone running a payment application, etc.) over a reader device 822 to complete a transaction via short-range communication (e.g., NFC, RFID, Bluetooth®, BLE, etc.). Short-range communication enables the payment instrument to exchange information with the reader device 822. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 824, the server computing device(s) 802, and/or the server computing device(s) 810 may exchange payment information and transaction data to determine whether transactions are authorized. For example, the POS system 824 may provide encrypted payment data, user authentication data, purchase amount information, point-of-purchase information, etc. (collectively, transaction data) to server computing device(s) 802 over the network(s) 804. The server computing device(s) 802 may send the transaction data to the server computing device(s) 810. As described above, in at least one example, the server computing device(s) 810 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server computing device(s) 810 associated therewith) can send a fund transfer request to a server computing device of a card payment network (e.g., Mastercard®, VISA®, etc.) to determine whether the transaction is authorized or deficient. In at least one example, the service provider 812 can serve as an acquirer and connect directly with the card payment network.

The card payment network (e.g., the server computing device(s) 810 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server computing device(s) 810 associated therewith) can make a determination as to whether the customer has the capacity to absorb the relevant charge associated with the payment transaction. In at least one example, the service provider 812 can serve as an issuer and/or can partner with an issuer. The transaction is either approved or rejected by the issuer and/or the card payment network (e.g., the server computing device(s) 810 associated therewith), and a payment authorization message is communicated from the issuer to the POS device via a path opposite of that described above, or via an alternate path.

As described above, the server computing device(s) 810, which can be associated with payment service provider(s), may determine whether the transaction is authorized based on the transaction data, as well as information relating to parties to the transaction (e.g., the customer 820 and/or the merchant 816(A)). The server computing device(s) 810 may send an authorization notification over the network(s) 804 to the server computing device(s) 802, which may send the authorization notification to the POS system 824 over the network(s) 804 to indicate whether the transaction is authorized. The server computing device(s) 802 may also transmit additional information such as transaction identifiers to the POS system 824. In one example, the server computing device(s) 802 may include a merchant application and/or other functional components for communicating with the POS system 824 and/or the server computing device(s) 810 to authorize or decline transactions.

Based on the authentication notification that is received by the POS system 824 from server computing device(s) 802, the merchant 816(A) may indicate to the customer 820 whether the transaction has been approved. In some examples, approval may be indicated at the POS system 824, for example, at a display of the POS system 824. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider 812 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, payment services, onboarding services, identity verification (IDV) services, and so on. In some examples, the users 814 can access all of the services of the service provider 812. In other examples, the users 814 can have gradated access to the services, which can be based on risk tolerance, IDV outputs, subscriptions, and so on. In at least one example, access to such services can be availed to the merchants 816 via the POS application 818. In additional or alternative examples, each service can be associated with its own access point (e.g., application, web browser, etc.).

The service provider 812 can offer payment processing services for processing payments on behalf of the merchants 816, as described above. For example, the service provider 812 can provision payment processing software, payment processing hardware and/or payment processing services to merchants 816, as described above, to enable the merchants 816 to receive payments from the customers 820 when conducting POS transactions with the customers 820. For instance, the service provider 812 can enable the merchants 816 to receive cash payments, payment card payments, and/or electronic payments from customers 820 for POS transactions and the service provider 812 can process transactions on behalf of the merchants 816.

As the service provider 812 processes transactions on behalf of the merchants 816, the service provider 812 can maintain accounts or balances for the merchants 816 in one or more ledgers. For example, the service provider 812 can analyze transaction data received for a transaction to determine an amount of funds owed to a merchant 816(A) for the transaction. In at least one example, such an amount can be a total purchase price less fees charged by the service provider 812 for providing the payment processing services. Based on determining the amount of funds owed to the merchant 816(A), the service provider 812 can deposit funds into an account of the merchant 816(A). The account can have a stored balance, which can be managed by the service provider 812. The account can be different from a conventional bank account at least because the stored balance is managed by a ledger of the service provider 812 and the associated funds are accessible via various withdrawal channels including, but not limited to, scheduled deposit, same-day deposit, instant deposit, and a linked payment instrument.

A scheduled deposit can occur when the service provider 812 transfers funds associated with a stored balance of the merchant 816(A) to a bank account of the merchant 816(A) that is held at a bank or other financial institution (e.g., associated with the server computing device(s) 810). Scheduled deposits can occur at a prearranged time after a POS transaction is funded, which can be a business day after the POS transaction occurred, or sooner or later. In some examples, the merchant 816(A) can access funds prior to a scheduled deposit. For instance, the merchant 816(A) may have access to same-day deposits (e.g., wherein the service provider 812 deposits funds from the stored balance to a linked bank account of the merchant on a same day as POS transaction, in some examples prior to the POS transaction being funded) or instant deposits (e.g., wherein the service provider 812 deposits funds from the stored balance to a linked bank account of the merchant on demand, such as responsive to a request). Further, in at least one example, the merchant 816(A) can have a payment instrument that is linked to the stored balance that enables the merchant to access the funds without first transferring the funds from the account managed by the service provider 812 to the bank account of the merchant 816(A).

In at least one example, the service provider 812 may provide inventory management services. That is, the service provider 812 may provide inventory tracking and reporting. Inventory management services may enable the merchant 816(A) to access and manage a database storing data associated with a quantity of each item that the merchant 816(A) has available (i.e., an inventory). Furthermore, in at least one example, the service provider 812 can provide catalog management services to enable the merchant 816(A) to maintain a catalog, which can be a database storing data associated with items that the merchant 816(A) has available for acquisition (i.e., catalog management services). In at least one example, the catalog may include a plurality of data items and a data item of the plurality of data items may represent an item that the merchant 816(A) has available for acquisition. The service provider 812 can offer recommendations related to pricing of the items, placement of items on the catalog, and multi-party fulfilment of the inventory.

In at least one example, the service provider 812 can provide business banking services, which allow can a merchant 816(A) to track deposits (from payment processing and/or other sources of funds) into an account of the merchant 816(A), payroll payments from the account (e.g., payments to employees of the merchant 816(A)), payments to other merchants (e.g., business-to-business) directly from the account or from a linked debit card, withdrawals made via scheduled deposit and/or instant deposit, etc. Furthermore, the business banking services can enable the merchant 816(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 816 to visualize their cash flow to track their financial health, set aside money for upcoming obligations (e.g., savings), organize money around goals, etc.

Banking services provided by the service provider 812 can include banking services for individual users such to enable individual users to track deposits, payroll payments, payments to other users, payments made via linked payment instruments, and/or the like. In some examples, banking services availed via the service provider 812 can enable users to make deposits, withdrawals, asset purchases, and/or manage one or more accounts, including spending accounts, savings accounts, credit accounts, and/or the like.

In at least one example, the service provider 812 can provide financing services and products, such as via business loans, consumer loans, fixed term loans, flexible term loans, and the like. In at least one example, the service provider 812 can utilize one or more risk signals to determine whether to extend financing offers and/or terms associated with such financing offers.

In at least one example, the service provider 812 can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider 812 can offer different types of capital loan products. For instance, in at least one example, the service provider 812 can offer a daily repayment loan product, wherein a capital loan is repaid daily, for instance, from a portion of transactions processed by the payment processing service on behalf of the borrower. Additionally and/or alternatively, the service provider 812 can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on. The financing service can additionally or alternatively offer loans to customers, payers, payors, and/or other types of users.

Additionally or alternatively, the service provider 812 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 816. The service provider 812 can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider 812 (e.g., from payments owed to the merchant from payments processed on behalf of the merchant, funds transferred to the merchant, etc.). The service provider 812 can offer specific financial products, such as payment instruments, tied specifically to the loan products. For example, in one implementation, the server provider 812 associates capital with a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider 812 can provide web-development services, which enable users 814 who are unfamiliar with HTML, XML, JavaScript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 816. In at least one example, the service provider 812 can recommend and/or generate content items to supplement omni-channel presences of the merchants 816. That is, if a merchant of the merchants 816 has a web page, the service provider 812—via the web-development or other services—can recommend and/or generate additional content items to be presented via other channel(s), such as social media, email, etc.

Furthermore, the service provider 812 can provide payroll services to enable employers to pay employees for work performed on behalf of employers. In at least one example, the service provider 812 can receive data that includes time worked by an employee (e.g., through imported timecards and/or POS interactions), sales made by the employee, gratuities received by the employee, and so forth. Based on such data, the service provider 812 can make payroll payments to employee(s) on behalf of an employer via the payroll service. For instance, the service provider 812 can facilitate the transfer of a total amount to be paid out for the payroll of an employee from the bank of the employer to the bank of the service provider 812 to be used to make payroll payments. In at least one example, when the funds have been received at the bank of the service provider 812, the service provider 812 can pay the employee, such as by check or direct deposit, often a day, a week, or more after when the work was actually performed by the employee. In additional or alternative examples, the service provider 812 can enable employee(s) to receive payments via same-day or instant deposit based at least in part on risk and/or reliability analyses performed by the service provider 812. In some examples, payroll services provided by the service provider 812 can enable users to access payroll data for managing timing, amounts, and/or recipients of payroll payments.

Moreover, in at least one example, the service provider 812 can provide employee management services for managing schedules of employees. Further, the service provider 812 can provide appointment services for enabling users 814 to set schedules for scheduling appointments and/or users 814 to schedule appointments.

In some examples, the service provider 812 can provide restaurant management services to enable users 814 to make and/or manage reservations, to monitor front-of-house and/or back-of-house operations, and so on. In such examples, the merchant device(s) 808 and/or server computing device(s) 802 can be configured to communicate with one or more other computing devices, which can be located in the front-of-house (e.g., POS device(s)) and/or back-of-house (e.g., kitchen display system(s) (KDS)). In at least one example, the service provider 812 can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider 812 can provide fulfilment services, which can use couriers for delivery, wherein couriers can travel between multiple locations to provide delivery services, photography services, etc. Couriers can be users 814 who can travel between locations to perform services for a requesting user 814 (e.g., deliver items, capture images, etc.). In some examples, the courier can receive compensation from the service provider 812. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider 812 can receive requests for courier services, automatically assign the requests to active couriers, and communicate dispatch instructions to couriers via user interface (e.g., application, web browser, or other access point) presented via respective devices 806.

In some examples, the service provider 812 can provide omni-channel fulfillment services. For instance, if a customer places an order with a merchant and the merchant cannot fulfill the order because one or more items are out of stock or otherwise unavailable, the service provider 812 can leverage other merchants and/or sales channels that are part of the platform of the service provider 812 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider 812 can enable conversational commerce via conversational commerce services, which can use one or more machine learning mechanisms to analyze messages exchanged between two or more users 814, voice inputs into a virtual assistant or the like, to determine intents of user(s) 814. In some examples, the service provider 812 can utilize determined intents to automate customer service, offer promotions, provide recommendations, or otherwise interact with customers in real-time. In at least one example, the service provider 812 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, the service provider 812 can provide payment services, which can enable users 814 to transfer funds to other users 814. An example of such a payment service is a peer-to-peer payment service that enables peer-to-peer payments between two or more users 814. In at least one example, the service provider 812 can communicate with instances of a mobile payment application 826 (or other access point) installed on devices 806 configured for operation by users 814, such as the user 828 illustrated in FIG. 8. In an example, an instance of the payment application executing on a first device operated by a payor can send a request to the service provider 812 to transfer an amount of funds (e.g., fiat currency or non-fiat currency such as cryptocurrency, securities, and related assets) from an account of the payor to an account of a payee (e.g., a peer-to-peer payment). The service provider 812 can facilitate the transfer and can send a notification to an instance of the payment application executing on a second mobile device operated by the payee that the transfer is in process (or has been completed). In some examples, the service provider 812 can send additional or alternative information to the instances of the payment application (e.g., low balance to the payor, current balance to the payor or the payee, etc.). In some implementations, the payor and/or payee can be identified automatically, e.g., based on context, proximity, prior transaction history, and so on. In other examples, the payee can send a request for funds to the payor prior to the payor initiating the transfer of funds. The funds transferred can be associated with any digital currency type, including, but not limited to, cash, cryptocurrency, etc. In some embodiments, the service provider 812 funds the request to payee on behalf of the payor, to speed up the transfer process and compensate for any lags that may be attributed to payor's financial network.

In some implementations, the service provider 812 can trigger the peer-to-peer payment process through identification of a “payment proxy” having a particular syntax. For example, the syntax includes a monetary currency indicator prefixing one or more alphanumeric characters (e.g., $Cash). The currency indicator operates as the tagging mechanism that indicates to a computer system to treat the inputs as a request from the sender to transfer cash, where detection of the syntax (which includes one or more alphanumeric characters tagged by a monetary currency indicator) triggers a transfer of cash. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. The peer-to-peer process can be initiated through a particular application executing on the user devices 806.

In some embodiments, the peer-to-peer process can be implemented within a forum context. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. The forum can be employed by a content provider to enable users of the forum to interact with one another, (e.g., through creating messages, posting comments, etc.). In some embodiments, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application context, such as a messaging application context. The term “messaging application,” as used here, refers to any messaging application that enables communication between users (e.g., sender and recipient of a message) over a wired or wireless communications network, through use of a communication message. The messaging application can be employed by the service provider 812. For instance, the service provider 812 can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 806 (e.g., mobile device or conventional personal computer (PC)) based on instructions transmitted to and from the server computing device(s) 802 (which, in such an example can be called a “messaging server”). In some instances, the messaging application can include a payment application with messaging capability that enables users of the payment application to communicate with one another. In such instances, the payment application can be executed on the user device 806 based on instructions transmitted to and from the server computing device(s) 802 (e.g., the payment service discussed in this description or another payment service that supports payment transactions).

In at least some embodiments, the peer-to-peer process can be implemented within a landing page context. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider 812 can generate the landing page to enable the recipient to conveniently receive one or more payments from one or more senders. In some embodiments, the personalized location address identifying the landing page is a uniform resource locator (URL) that incorporates the payment proxy. In such embodiments, the landing page is a web page, e.g., www.cash.me/$Cash.

In some examples, the mobile payment application 826 can provide more than payment transferring services. For instance, in at least one example, the user 828 can utilize the mobile payment application 826 for accessing banking services, payroll services, and/or other services available from the service provider 812, as described above. The mobile payment application 826 (and in some cases, the POS application 818) may be the same as or similar to the mobile payment application 112 introduced in FIG. 1.

In accordance with the examples described herein, a credential(s) 120 may be received via a user interface presented by the mobile payment application 826 associated with the service provider 812, the credential being associated with a user account of a user 828 and a third-party service provider associated with the server(s) 810. The mobile payment application 826 may then send the credential(s) 120 to a computing device(s) of the third-party service provider (e.g., the server(s) 810), which causes a session to be established between the mobile payment application 826 and the third-party device(s) (e.g., the server(s) 810). The mobile payment application 826 may receive, via the session, user data associated with the user account from the third-party device(s) (e.g., the server(s) 810), and may send, without having provided the credential(s) 120 to a computing device(s) (e.g., the server(s) 802) of the service provider 812, at least a portion of the user data to the computing device(s) (e.g., the server(s) 802) of the service provider 812.

In at least one example, a user 814 may be new to the service provider 812 such that the user 814 that has not registered (e.g., subscribed to receive access to one or more services offered by the service provider) with the service provider 812. The service provider 812 can offer onboarding services for registering a potential user 814 with the service provider 812. In some examples, onboarding can involve presenting various questions, prompts, and the like to a potential user 814 to obtain information that can be used to generate a profile for the potential user 814. In at least one example, the service provider 812 can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 814 providing all necessary information, the potential user 814 can be onboarded to the service provider 812. In such an example, any limited or short-term access to services of the service provider 812 can be transitioned to more permissive (e.g., less limited) or longer-term access to such services.

The service provider 812 can be associated with IDV services, which can be used by the service provider 812 for compliance purposes and/or can be offered as a service, for instance to third-party service providers (e.g., associated with the server computing device(s) 810). That is, the service provider 812 can offer IDV services to verify the identity of users 814 seeking to use or using their services. Identity verification requires a customer (or potential customer) to provide information that is used by compliance departments to prove that the information is associated with an identity of a real person or entity. In at least one example, the service provider 812 can perform services for determining whether identifying information provided by a user 814 accurately identifies the customer (or potential customer) (i.e., Is the customer who they say they are?).

The service provider 812 is capable of providing additional or alternative services and the services described above are offered as a sampling of services. In at least one example, the service provider 812 can exchange data with the server computing device(s) 810 associated with third-party service providers. Such third-party service providers can provide information that enables the service provider 812 to provide services, such as those described above. In additional or alternative examples, such third-party service providers can access services of the service provider 812. That is, in some examples, the third-party service providers can be subscribers, or otherwise access, services of the service provider 812.

Techniques described herein can be configured to operate in both real-time/online and offline modes. “Online” modes refer to modes when devices are capable of communicating with the service provider 812 (e.g., the server computing device(s) 802) and/or the server computing device(s) 810 via the network(s) 804. In some examples, the merchant device(s) 808 are not capable of connecting with the service provider 812 (e.g., the server computing device(s) 802) and/or the server computing device(s) 810, due to a network connectivity issue, for example. In additional or alternative examples, the server computing device(s) 802 are not capable of communicating with the server computing device(s) 810 due to network connectivity issue, for example. In such examples, devices may operate in “offline” mode where at least some payment data is stored (e.g., on the merchant device(s) 808) and/or the server computing device(s) 802 until connectivity is restored and the payment data can be transmitted to the server computing device(s) 802 and/or the server computing device(s) 810 for processing.

In at least one example, the service provider 812 can be associated with a hub, such as an order hub, an inventory hub, a fulfillment hub and so on, which can enable integration with one or more additional service providers (e.g., associated with the additional server computing device(s) 810). In some examples, such additional service providers can offer additional or alternative services and the service provider 812 can provide an interface or other computer-readable instructions to integrate functionality of the service provider 812 into the one or more additional service providers.

Techniques described herein are directed to services provided via a distributed system of user devices 806 that are in communication with one or more server computing devices 802 of the service provider 812. That is, techniques described herein are directed to a specific implementation—or, a practical application—of utilizing a distributed system of user devices 806 that are in communication with one or more server computing devices 802 of the service provider 812 to perform a variety of services, as described above. The unconventional configuration of the distributed system described herein enables the server computing device(s) 802 that are remotely-located from end-users (e.g., users 814) to intelligently offer services based on aggregated data associated with the end-users, such as the users 814 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider 812, and those outside of the control of the service provider 812, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 814 and user devices 806. Furthermore, such features are changed dynamically based on the profiles of the users involved interacting with the GUIs. As such, techniques described herein are directed to improvements to computing systems.

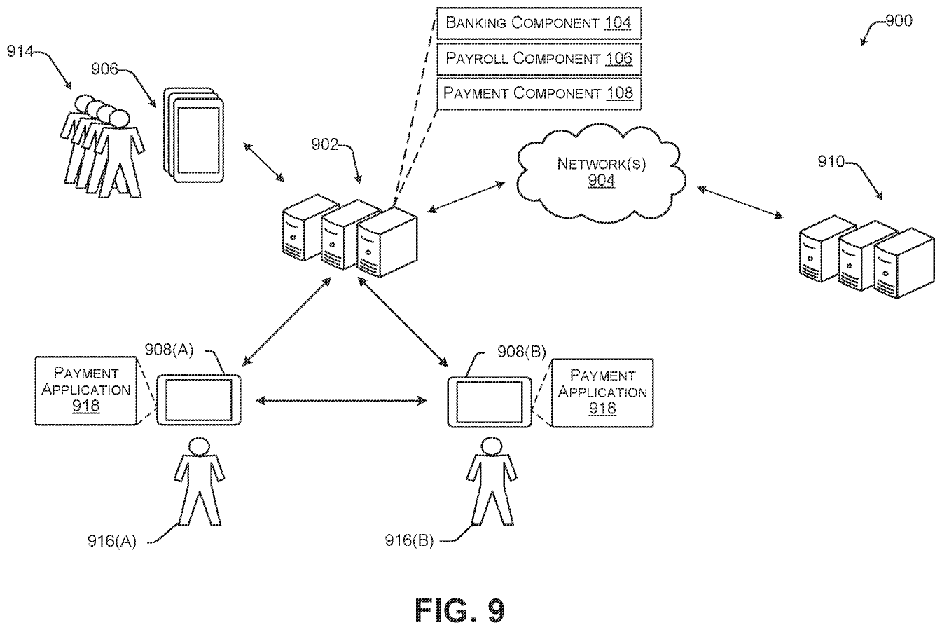

FIG. 9 is an example environment 900 for performing techniques described herein. The environment 900 includes server(s) 902 that can communicate over a network 904 with user devices 906 (which, in some examples can be user devices 908 (individually, 908(A), 908(B)) and/or server(s) 910 associated with third-party service provider(s). The server(s) 902 can be associated with a service provider that can provide one or more services for the benefit of users 914, as described below. Actions attributed to the service provider can be performed by the server(s) 902. In some examples, the service provider 812 referenced in FIG. 8 can be the same or different than the service provider referenced in FIG. 9.

For example, the server(s) 902 may be the same as or similar to the server(s) 102 introduced in FIG. 1, and the server(s) 902 may implement the banking component 104, the payroll component 106, and/or the payment component 108. Furthermore, the network(s) 904 may be the same as or similar to the network(s) 116 introduced in FIG. 1.

The environment 900 can include a plurality of user devices 906, as described above. Each one of the plurality of user devices 906 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. The user devices 906 (and in some examples, the user devices 908) may be the same as or similar to the user computing device 114 introduced in FIG. 1. In some examples, individual ones of the user devices can be operable by users 914. The users 914 can be referred to as customers, buyers, merchants, sellers, borrowers, employees, employers, payors, payees, couriers and so on. The users 914 can interact with the user devices 906 via user interfaces presented via the user devices 906. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 906 can have an instance or versioned instance of an application, which can be downloaded from an application store, for example, which can present the user interface(s) described herein. In at least one example, a user 914 can interact with the user interface via touch input, spoken input, or any other type of input.

In at least one example, the service provider can provide a peer-to-peer payment service that enables peer-to-peer payments between two or more users 914. Two users, user 916(A) and user 916(B) are illustrated in FIG. 9 as “peers” in a peer-to-peer payment. In at least one example, the service provider can communicate with instances of a payment application 918 (or other access point) installed on devices 906 configured for operation by users 914. In an example, an instance of the payment application 918 executing on a first device 908(A) operated by a payor (e.g., user 916(A)) can send a request to the service provider to transfer an asset (e.g., fiat currency, non-fiat currency, cryptocurrency, securities, gift cards, and/or related assets) from the payor to a payee (e.g., user 916(B)) via a peer-to-peer payment. In some examples, assets associated with an account of the payor are transferred to an account of the payee. In some examples, assets can be held at least temporarily in an account of the service provider prior to transferring the assets to the account of the payee. The payment application 918 may be the same as or similar to the mobile payment application 112 introduced in FIG. 1.

In accordance with the examples described herein, a credential(s) 120 may be received via a user interface presented by the payment application 918 associated with a service provider associated with the server(s) 902, the credential being associated with a user account of a user 916 and a third-party service provider associated with the server(s) 910. The payment application 918 may then send the credential(s) 120 to a computing device(s) of the third-party service provider (e.g., the server(s) 910), which causes a session to be established between the payment application 918 and the third-party device(s) (e.g., the server(s) 910). The payment application 918 may receive, via the session, user data associated with the user account from the third-party device(s) (e.g., the server(s) 910), and may send, without having provided the credential(s) 120 to a computing device(s) (e.g., the server(s) 902) of the service provider, at least a portion of the user data to the computing device(s) (e.g., the server(s) 902) of the service provider.

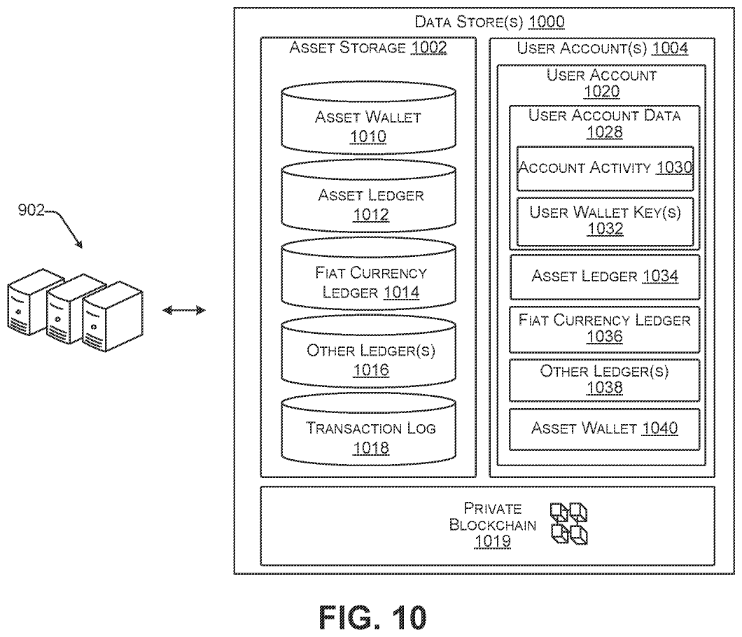

In some examples, the service provider can utilize a ledger system to track transfers of assets between users 914, 916. FIG. 10, below, provides additional details associated with such a ledger system. The ledger system can enable users 914, 916 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 918 executing on user device(s) of payee(s). As an example, the service provider can transfer assets from an account of user 916(A) to an account of the user 916(B) and can send a notification to the user device 908(B) of the user 916(B) for presentation via a user interface. The notification can indicate that a transfer is in process, a transfer is complete, or the like. In some examples, the service provider can send additional or alternative information to the instances of the payment application 918 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 902 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 918 executing on the user devices 906. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider as described with reference to FIG. 9 or a third-party service provider associated with the server(s) 910. In examples where the content provider is a third-party service provider, the server(s) 910 can be accessible via one or more APIs or other integrations. The forum can be employed by a content provider to enable users of the forum to interact with one another (e.g., through creating messages, posting comments, etc.). In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 9. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 906 (e.g., mobile device or conventional personal computer (PC)) based on instructions transmitted to and from the server(s) 902 (which, in such an example can be called a “messaging server”). In some instances, the messaging application can include a payment application with messaging capability that enables users of the payment application to communicate with one another. In such instances, the payment application can be executed on a user device 906 based on instructions transmitted to and from the server(s) 902 (e.g., the payment service discussed in this description or another payment service that supports payment transactions). In some examples, the messaging application can be provided by a third-party service provider associated with the server(s) 910. In examples where the messaging application is a third-party service provider, the server(s) 910 can be accessible via one or more APIs or other integrations.

As described above, the service provider can facilitate peer-to-peer transactions, which can enable users 914, 916 to transfer fiat currency, non-fiat currency, cryptocurrency, securities, or other assets, or portions thereof, to other users 914, 916. In at least one example, individual users can be associated with user accounts. Additional details associated with user accounts and the transfer of assets between users 914, 916 are described below with reference to FIG. 10.

Furthermore, the service provider of FIG. 9 can enable users 914, 916 to perform banking transactions via instances of the payment application 918. For example, users can configure direct deposits or other deposits for adding assets to their various ledgers/balances. Further, users 914, 916 can configure bill pay, recurring payments, and/or the like using assets associated with their accounts. In addition to sending and/or receiving assets via peer-to-peer transactions, users 914, 916 buy and/or sell assets via asset networks such as cryptocurrency networks, securities networks, and/or the like.

FIG. 10 is an example data store 1000 used for performing techniques described herein. The data store(s) 1000 can be associated with the server(s) 1002. The data store(s) 1000 may be the same as or similar to the data store(s) 110 introduced in FIG. 1.

In at least one example, the data store(s) 1000 can store assets in an asset storage 1002, as well as data in user account(s) 1004, merchant account(s) 1006, and/or customer account(s) 1008. In at least one example, the asset storage 1002 can be used to store assets managed by the service provider of FIG. 10. In at least one example, the asset storage 1002 can be used to record whether individual of the assets are registered to users. For example, the asset storage 1002 can include an asset wallet 1010 for storing records of assets owned by the service provider of FIG. 9, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 910 can be associated therewith. In some examples, the asset wallet 1010 can communication with the asset network via one or more components associated with the server(s) 902.

The asset wallet 1010 can be associated with one or more addresses and can vary addresses used to acquire assets (e.g., from the asset network(s)) so that its holdings are represented under a variety of addresses on the asset network. In examples where the service provider of FIG. 9 has its own holdings of cryptocurrency (e.g., in the asset wallet 1010), a user can acquire cryptocurrency directly from the service provider of FIG. 9. In some examples, the service provider of FIG. 10 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1002 may contain ledgers that store records of assignments of assets to users 1014, 1016. Specifically, the asset storage 1002 may include asset ledger 1010, fiat currency ledger 1014, and other ledger(s) 1016, which can be used to record transfers of assets between users 914, 916 of the service provider and/or one or more third-parties (e.g., merchant network(s), payment card network(s), ACH network(s), equities network(s), the asset network, securities networks, etc.). In doing so, the asset storage 1002 can maintain a running balance of assets managed by the service provider of FIG. 9. The ledger(s) of the asset storage 1002 can further indicate some of the running balance for each of the ledger(s) stored in the asset storage 1002 is assigned or registered to one or more user account(s) 1004.

In at least one example, the asset storage 1002 can include transaction logs 1018, which can include records of past transactions involving the service provider of FIG. 9. In at least one example, transaction data, as described herein, can be stored in association with the transaction logs 1018.

In some examples, the data store(s) 1000 can store a private blockchain 1019. A private blockchain 1019 can function to record sender addresses, recipient addresses, public keys, values of cryptocurrency transferred, and/or can be used to verify ownership of cryptocurrency tokens to be transferred. In some examples, the service provider of FIG. 9 can record transactions taking place within the service provider of FIG. 9 involving cryptocurrency until the number of transactions has exceeded a determined limit (e.g., number of transactions, storage space allocation, etc.). Based at least in part on determining that the limit has been reached, the service provider of FIG. 9 can publish the transactions in the private blockchain 1019 to a public blockchain (e.g., associated with the asset network), where miners can verify the transactions and record the transactions to blocks on the public blockchain. In at least one example, the service provider of FIG. 10 can participate as miner(s) at least for its transactions to be posted to the public blockchain.

In at least one example, the data store(s) 1000 can store and/or manage accounts, such as user account(s) 1004, merchant account(s) 1006, and/or customer account(s) 1008. In at least one example, the user account(s) 1004 may store records of user accounts associated with the users 914. In at least one example, the user account(s) 1004 can include a user account 1020, which can be associated with a user (of the users 914). Other user accounts of the user account(s) 1004 can be similarly structured to the user account 1 0 20, according to some examples. In other examples, other user accounts may include more or less data and/or account information than that provided by the user account 1020. In at least one example, the user account 1020 can include user account data 1028, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1028 can include account activity 1030 and user wallet key(s) 1032. The account activity 1030 may include a transaction log for recording transactions associated with the user account 1020. In some examples, the user wallet key(s) 1032 can include a public-private key-pair and a respective address associated with the asset network or other asset networks. In some examples, the user wallet key(s) 1032 may include one or more key pairs, which can be unique to the asset network or other asset networks.

In addition to the user account data 1028, the user account 1020 can include ledger(s) for account(s) managed by the service provider of FIG. 9, for the user. For example, the user account 1020 may include an asset ledger 1034, a fiat currency ledger 1036, and/or one or more other ledgers 1038. The ledger(s) can indicate that a corresponding user utilizes the service provider of FIG. 9 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 10.

In some examples, the asset ledger 1034 can store a balance for each of one or more cryptocurrencies (e.g., Bitcoin, Ethereum, Litecoin, etc.) registered to the user account 1020. In at least one example, the asset ledger 1034 can further record transactions of cryptocurrency assets associated with the user account 1020. For example, the user account 1020 can receive cryptocurrency from the asset network using the user wallet key(s) 1032. In some examples, the user wallet key(s) 1032 may be generated for the user upon request. User wallet key(s) 1032 can be requested by the user in order to send, exchange, or otherwise control the balance of cryptocurrency held by the service provider of FIG. 9 (e.g., in the asset wallet 1010) and registered to the user. In some examples, the user wallet key(s) 1032 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 9 and the value is credited as a balance in asset ledger 1034), by purchasing currency in the form associated with the account using currency in a different form (e.g., buying a value of cryptocurrency from the service provider of FIG. 9 using a value of fiat currency reflected in fiat currency ledger, and crediting the value of cryptocurrency in asset ledger 1034), or by conducting a transaction with another user (customer or merchant) of the service provider of FIG. 9 wherein the account receives incoming currency (which can be in the form associated with the account or a different form, in which the incoming currency may be converted to the form associated with the account). In some examples, the user account data 1028 can include preferences for maintaining balances of individual of the ledgers. For example, the service provider of FIG. 9 can automatically debit the fiat currency ledger 1036 to increase the asset ledger 1034, or another account associated with the user whenever the cryptocurrency balance (e.g., of the asset ledger 1034) falls below a stated level (e.g., a threshold). Conversely, in some embodiments, the service provider of FIG. 9 can automatically credit the fiat currency ledger 1036 to decrease the asset ledger 1034 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with the third-party server(s) 120) unrelated to the service provider of FIG. 10 (i.e., an external account). In at least one example, the user can transfer all or a portion of a balance of the cryptocurrency stored in the third-party cryptocurrency wallet to the service provider of FIG. 10. Such a transaction can require the user to transfer an amount of the cryptocurrency in a message signed by user's private key to an address provided by the service provider of FIG. 10. In at least one example, the transaction can be sent to miners to bundle the transaction into a block of transactions and to verify the authenticity of the transactions in the block. Once a miner has verified the block, the block is written to a public, distributed blockchain where the service provider of FIG. 10 can then verify that the transaction has been confirmed and can credit the user's asset ledger 1034 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 9. As described above, in some examples, the service provider of FIG. 9 can acquire cryptocurrency from a third-party source (e.g., associated with the third-party server(s) 118). In such examples, the asset wallet 1010 can be associated with different addresses and can vary addresses used to acquire cryptocurrency so that its holdings are represented under a variety of addresses on a blockchain. When the service provider of FIG. 9 has their own holdings of cryptocurrency, users can acquire cryptocurrency directly from the service provider of FIG. 9. In some examples, the service provider of FIG. 9 can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 9 has its own cryptocurrency assets, cryptocurrency transferred in a transaction (e.g., data with address provided for receipt of transaction and a balance of cryptocurrency transferred in the transaction) can be stored in the asset wallet 1010. In at least one example, the service provider of FIG. 9 can credit the asset ledger 1034 of the user. Additionally, while the service provider of FIG. 9 recognizes that the user retains the value of the transferred cryptocurrency through crediting the asset ledger 1034, any person that inspects the blockchain will see the cryptocurrency as having been transferred to the service provider of FIG. 9. In some examples, the asset wallet 1010 can be associated with many different addresses. In such examples, any person that inspects the blockchain may not easily associate all cryptocurrency stored in asset wallet 1010 as belonging to the same entity. It is this presence of a private ledger that is used for real-time transactions and maintained by the service provider of FIG. 9, combined with updates to the public ledger at other times, that allows for extremely fast transactions using cryptocurrency to be achieved. In some examples, the “private ledger” can refer to the asset ledger 1010, which in some examples, can utilize the private blockchain 1019, as described herein. The “public ledger” can correspond to a public blockchain associated with the asset network.

In at least one example, a user's asset ledger 1034, fiat currency ledger 1036, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1034. In some examples, a user can receive fiat currency or another currency in the form of payment for a transaction with another user. In at least one example, at least a portion of such funds can be converted into cryptocurrency by the service provider of FIG. 9 and used to fund the asset ledger 1034 of the user.

As addressed above, in some examples, users can also have other accounts maintained by the service provider of FIG. 9. For example, a user can also have an account in U.S. dollars, which can be tracked, for example, via the fiat currency ledger 1036. Such an account can be funded by transferring money from a bank account at a third-party bank to an account maintained by the service provider of FIG. 9 as is conventionally known. In some examples, a user can receive fiat currency in the form of payment for a transaction with another user. In such examples, at least a portion of such funds can be used to fund the fiat currency ledger 1036.

In some examples, a user can have one or more internal payment cards registered with the service provider of FIG. 9. Internal payment cards can be linked to one or more of the accounts associated with the user account 1020. In some embodiments, options with respect to internal payment cards can be adjusted and managed using an application (e.g., the payment application 918).

In at least one example, as described above, each ledger can correspond to an account of the user that is managed by the service provider of FIG. 9. In at least one example, individual of the accounts can be associated with a wallet or a stored balance for use in payment transactions, peer-to-peer transactions, payroll payments, etc.

In at least one example, the user account 1020 can be associated with an asset wallet 1040. The asset wallet 1040 of the user can be associated with account information that can be stored in the user account data 1028 and, in some examples, can be associated with the user wallet key(s) 1032. In at least one example, the asset wallet 1040 can store data indicating an address provided for receipt of a cryptocurrency transaction. In at least one example, the balance of the asset wallet 1040 can be based at least in part on a balance of the asset ledger 1034. In at least one example, funds availed via the asset wallet 1040 can be stored in the asset wallet 1040 or the asset wallet 1010. Funds availed via the asset wallet 1010 can be tracked via the asset ledger 1034. The asset wallet 1040, however, can be associated with additional cryptocurrency funds.

In at least one example, when the service provider of FIG. 9 includes a private blockchain 1019 for recording and validating cryptocurrency transactions, the asset wallet 1040 can be used instead of, or in addition to, the asset ledger 1034. For example, at least one example, a merchant can provide the address of the asset wallet 1040 for receiving payments. In an example where a customer is paying in cryptocurrency and the customer has their own cryptocurrency wallet account associated with the service provider of FIG. 9, the customer can send a message signed by its private key including its wallet address (i.e., of the customer) and identifying the cryptocurrency and value to be transferred to the merchant's asset wallet 1040. The service provider of FIG. 9 can complete the transaction by reducing the cryptocurrency balance in the customer's cryptocurrency wallet and increasing the cryptocurrency balance in the merchant's asset wallet 1040. In addition to recording the transaction in the respective cryptocurrency wallets, the transaction can be recorded in the private blockchain 1019 and the transaction can be confirmed. A user can perform a similar transaction with cryptocurrency in a peer-to-peer transaction as described above. In at least one example, the cryptocurrency wallet account 1030 can be funded by a balance transfer from a third-party cryptocurrency wallet, as described above. Such a transaction can require a user to transfer an amount of cryptocurrency in a message signed by the user's private key to an address of the cryptocurrency wallet account 1030. The transferred amount of cryptocurrency can then be within the cryptocurrency wallet account 1030 for use in later transactions.

While the asset ledger 1034 and/or asset wallet 1040 are each described above with reference to cryptocurrency, the asset ledger 1034 and/or asset wallet 1040 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider of FIG. 9 is an aspect of the technology disclosed that enables technical advantages of increased processing speed and improved security.

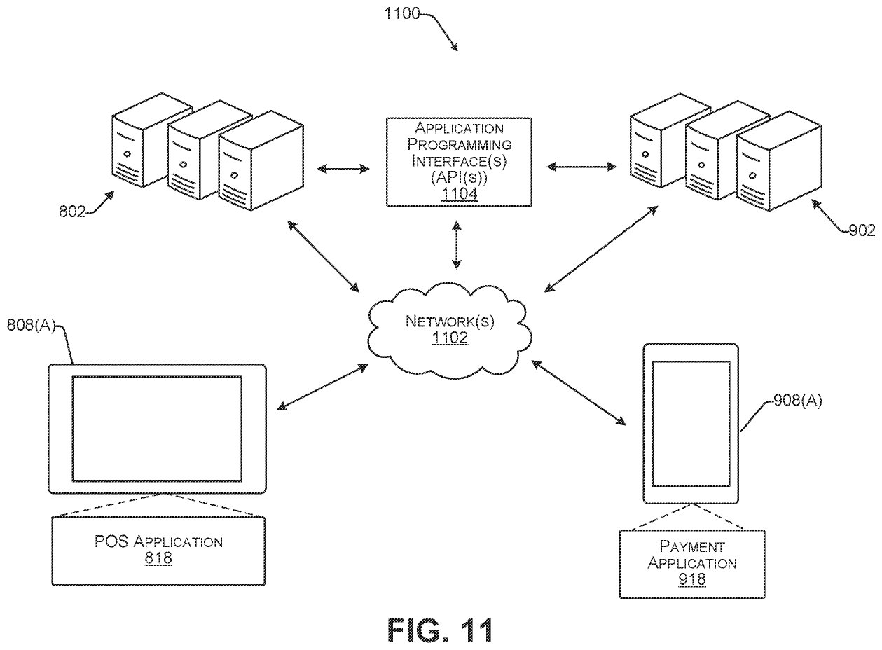

FIG. 11 is an example environment 1100 for performing techniques described herein. In the environment 1100, the environment 800 and the environment 900 can be integrated to enable payments at the point-of-sale using assets associated with user accounts in the peer-to-peer environment of FIG. 9. As illustrated, each of the components can communicate with one another via one or more networks 1102. In some examples, one or more APIs 1104 or other functional components can be used to facilitate such communication. For example, the APIs 1104 may be usable to communicate authentication details, details of data fetching, and/or data (e.g., payroll data 124), as described herein.

In at least one example, the example environment 1100 can enable contactless payments, via integration of peer-to-peer payment, or other payment making, platform(s) and payment processing platform(s), are described herein. For the purpose of FIG. 11, the environment 800 can refer to a payment processing platform and the environment 900 can refer to a peer-to-peer payment, or payment making, platform. In an example, such an integration can enable a customer to participate in a transaction via their own computing device instead of interacting with a merchant device of a merchant, such as the merchant device 808(A). In such an example, the POS application 818, associated with a payment processing platform and executable by the merchant device 808(A) of the merchant, can present a QR code, or other code that can be used to identify a transaction (e.g., a transaction code), in association with a transaction between the customer and the merchant. The QR code, or other transaction code, can be provided to the POS application 818 via an API associated with the peer-to-peer payment platform. In an example, the customer can utilize their own computing device, such as the user device 908(A), to capture the QR code, or the other transaction code, and to provide an indication of the captured QR code, or other transaction code, to server(s) 902 and/or server(s) 802.

Based at least in part on the integration of the peer-to-peer payment platform and the payment processing platform (e.g., via the API), the server(s) 802 and/or 902 associated with each can exchange communications with each other—and with a payment application 918 associated with the peer-to-peer payment platform and/or the POS application 818—to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, or other transaction code, specific to the transaction can be used for providing transaction details, location details, customer details, or the like to a computing device of the customer, such as the user device 908(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1008(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 818 and the payment application 918, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 908(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 818, associated with a payment processing platform, on the merchant device 808(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 808(A) can present a QR code, or other transaction code, that can be associated with a peer-to-peer payment platform. The customer can use a camera associated with the user device 908(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 818, associated with a payment processing platform, on the merchant device 808(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 818 can cause a text message with a resource locator (e.g., uniform resource locator (URL)) that can be associated with a peer-to-peer payment platform to be sent to the user device 908(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction—between the customer and the resource locator presented via the customer computing device—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 908(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 818 of a merchant device 808(A) at a brick-and-mortar store of a merchant to a payment application 918 of a user device 908(A) of a customer to enable the customer to participate in a transaction via their own computing device. For instance, in a “scan to pay” example as described above, based at least in part on capturing the QR code, or other transaction code, via the user device 908(A), the payment processing platform can provide transaction data to the peer-to-peer payment platform for presentation via the payment application 918 on the user device 908(A). In some examples, the customer can watch items being added to their cart (e.g., via a user interface presented via the payment application). As an item is added to a virtual cart by the merchant—via the POS application 818 on the merchant device 808(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 918 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 908(A) during or after payment of the transaction.

In some examples, based at least in part on capturing the QR code, or other transaction code, the payment processing platform can provide transaction data to the peer-to-peer payment platform for presentation via the payment application 918 on the computing device of the customer, such as the user device 908(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 918 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above—and also below—techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 818, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 918 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

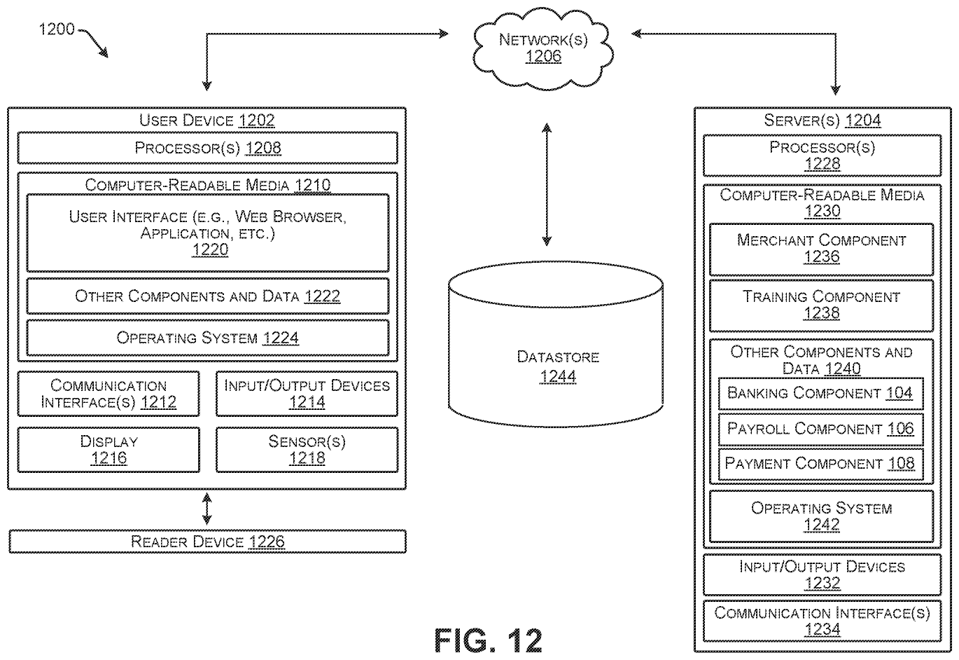

FIG. 12 depicts an illustrative block diagram illustrating a system 1200 for performing techniques described herein. The system 1200 includes a user device 1202, that communicates with server computing device(s) (e.g., server(s) 1204) via network(s) 1206 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1202 is illustrated, in additional or alternate examples, the system 1200 can have multiple user devices, as described above with reference to FIG. 9.

For example, the server(s) 1204 may be the same as or similar to the server(s) 102 introduced in FIG. 1. The user device 1202 may be the same as or similar to the user computing device 114 introduced in FIG. 1. Furthermore, the network(s) 1206 may be the same as or similar to the network(s) 116 introduced in FIG. 1.

In at least one example, the user device 1202 can be any suitable type of computing device, e.g., portable, semi-portable, semi-stationary, or stationary. Some examples of the user device 1202 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1202 can be any computing device capable of sending communications and performing the functions according to the techniques described herein. The user device 1202 can include devices, e.g., payment card readers, or components capable of accepting payments, as described below.

In the illustrated example, the user device 1202 includes one or more processors 1208, one or more computer-readable media 1210, one or more communication interface(s) 1212, one or more input/output (I/O) devices 1214, a display 1216, and sensor(s) 1218.

In at least one example, each processor 1208 can itself comprise one or more processors or processing cores. For example, the processor(s) 1208 can be implemented as one or more microprocessors, microcomputers, microcontrollers, digital signal processors, central processing units, state machines, logic circuitries, and/or any devices that manipulate signals based on operational instructions. In some examples, the processor(s) 1208 can be one or more hardware processors and/or logic circuits of any suitable type specifically programmed or configured to execute the algorithms and processes described herein. The processor(s) 1208 can be configured to fetch and execute computer-readable processor-executable instructions stored in the computer-readable media 1210.

Depending on the configuration of the user device 1202, the computer-readable media 1210 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1210 can include, but is not limited to, RAM, ROM, EEPROM, flash memory, solid-state storage, magnetic disk storage, optical storage, and/or other computer-readable media technology. Further, in some examples, the user device 1202 can access external storage, such as RAID storage systems, storage arrays, network attached storage, storage area networks, cloud storage, or any other medium that can be used to store information and that can be accessed by the processor(s) 1208 directly or through another computing device or network. Accordingly, the computer-readable media 1210 can be computer storage media able to store instructions, components or components that can be executed by the processor(s) 1208. Further, when mentioned, non-transitory computer-readable media exclude media such as energy, carrier signals, electromagnetic waves, and signals per se.

The computer-readable media 1210 can be used to store and maintain any number of functional components that are executable by the processor(s) 1208. In some implementations, these functional components comprise instructions or programs that are executable by the processor(s) 1208 and that, when executed, implement operational logic for performing the actions and services attributed above to the user device 1202. Functional components stored in the computer-readable media 1210 can include a user interface 1220 to enable users to interact with the user device 1202, and thus the server(s) 1204 and/or other networked devices. In at least one example, the user interface 1220 can be presented via a web browser, or the like. In other examples, the user interface 1220 can be presented via an application, such as a mobile application or desktop application, which can be provided by a service provider 612 associated with the server(s) 1204, or which can be an otherwise dedicated application. In some examples, the user interface 1220 can be the mobile payment application user interface 122 described above with reference to FIG. 1. In at least one example, a user can interact with the user interface via touch input, spoken input, gesture, or any other type of input. The word “input” is also used to describe “contextual” input that may not be directly provided by the user via the user interface 1220. For example, user's interactions with the user interface 1220 are analyzed using, e.g., natural language processing techniques, to determine context or intent of the user, which may be treated in a manner similar to “direct” user input.

In accordance with the examples described herein, a credential(s) 120 may be received via a user interface 1220 presented by the mobile payment application 112 associated with a service provider associated with the server(s) 1204, the credential being associated with a user account of a user and a third-party service provider associated with another server(s). The mobile payment application 112 may then send the credential(s) 120 to a computing device(s) of the third-party service provider, which causes a session to be established between the mobile payment application 112 and the third-party device(s). The mobile payment application 112 may receive, via the session, user data associated with the user account from the third-party device(s), and may send, without having provided the credential(s) 120 to a computing device(s) (e.g., the server(s) 1204) of the service provider, at least a portion of the user data to the computing device(s) (e.g., the server(s) 1204) of the service provider.

Depending on the type of the user device 1202, the computer-readable media 1210 can also optionally include other functional components and data, such as other components and data 1222, which can include programs, drivers, etc., and the data used or generated by the functional components. In addition, the computer-readable media 1210 can also store data, data structures and the like, that are used by the functional components. Further, the user device 1202 can include many other logical, programmatic and physical components, of which those described are merely examples that are related to the discussion herein.

In at least one example, the computer-readable media 1210 can include additional functional components, such as an operating system 1224 for controlling and managing various functions of the user device 1202 and for enabling basic user interactions.

The communication interface(s) 1212 can include one or more interfaces and hardware components for enabling communication with various other devices, such as over the network(s) 1206 or directly. For example, communication interface(s) 1212 can enable communication through one or more network(s) 1206, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1206 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1202 can further include one or more input/output (I/O) devices 1214. The I/O devices 1214 can include speakers, a microphone, a camera, and various user controls (e.g., buttons, a joystick, a keyboard, a keypad, etc.), a haptic output device, and so forth. The I/O devices 1214 can also include attachments that leverage the accessories (audio-jack, USB-C, Bluetooth, etc.) to connect with the user device 1202.

In at least one example, user device 1202 can include a display 1216. Depending on the type of computing device(s) used as the user device 1202, the display 1216 can employ any suitable display technology. For example, the display 1216 can be a liquid crystal display, a plasma display, a light emitting diode display, an OLED (organic light-emitting diode) display, an electronic paper display, or any other suitable type of display able to present digital content thereon. In at least one example, the display 1216 can be an augmented reality display, a virtually reality display, or any other display able to present and/or project digital content. In some examples, the display 1216 can have a touch sensor associated with the display 1216 to provide a touchscreen display configured to receive touch inputs for enabling interaction with a graphic interface presented on the display 1216. Accordingly, implementations herein are not limited to any particular display technology. Alternatively, in some examples, the user device 1202 may not include the display 1216, and information can be presented by other means, such as aurally, hapticly, etc.

In addition, the user device 1202 can include sensor(s) 1218. The sensor(s) 1218 can include a GPS device able to indicate location information. Further, the sensor(s) 1218 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 612, described above, to provide one or more services. That is, in some examples, the service provider 612 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 614 and/or for sending users 614 notifications regarding available appointments with merchant(s) located proximate to the users 614. In at least one example, location can be used for taking payments from nearby customers when they leave a geofence, or location can be used to initiate an action responsive to users 614 enter a brick-and-mortar store of a merchant. Location can be used in additional or alternative ways as well.

Additionally, the user device 1202 can include various other components that are not shown, examples of which include removable storage, a power source, such as a battery and power control unit, a barcode scanner, a printer, a cash drawer, and so forth.

In addition, in some examples, the user device 1202 can include, be connectable to, or otherwise be coupled to a reader device 1226, for reading payment instruments and/or identifiers associated with payment objects. In some examples, as described above, the reader device 1226 can plug in to a port in the user device 1202, such as a microphone port, a headphone port, an audio-jack, a data port, or other suitable port. In additional or alternative examples, the reader device 1226 can be coupled to the user device 1202 via another wired or wireless connection, such as via a Bluetooth®, BLE, and so on. The reader device 1226 can include a read head for reading a magnetic strip of a payment card, and further can include encryption technology for encrypting the information read from the magnetic strip. Additionally or alternatively, the reader device 1226 can be an EMV payment reader, which in some examples, can be embedded in the user device 1202. Moreover, numerous other types of readers can be employed with the user device 1202 herein, depending on the type and configuration of the user device 1202.

The reader device 1226 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1226 may include hardware implementation, such as slots, magnetic tracks, and rails with one or more sensors or electrical contacts to facilitate detection and acceptance of a payment instrument. That is, the reader device 1226 may include hardware implementations to enable the reader device 1226 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 1226 may also include a biometric sensor to receive and process biometric characteristics and process them as payment instruments, given that such biometric characteristics are registered with the payment service system 100 and connected to a financial account with a bank server.

The reader device 1226 may include processing unit(s), computer-readable media, a reader chip, a transaction chip, a timer, a clock, a network interface, a power supply, and so on. The processing unit(s) of the reader device 1226 may execute one or more components and/or processes to cause the reader device 1226 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 1226, the computer-readable media may include volatile memory (such as RAM), non-volatile memory (such as ROM, flash memory, miniature hard drive, memory card, or the like), or some combination thereof. In at least one example, the computer-readable media of the reader device 1226 may include at least one component for performing various functions as described herein.

The reader chip may perform functionalities to control the operations and processing of the reader device 1226. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock 1212, which may provide a clock signal indicating a time. Furthermore, the reader chip may perform functionality to control the network interface, which may interface with the network(s) 1206, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 1226. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1202, which can be a POS terminal, and the reader device 1226 are shown as separate devices, in additional or alternative examples, the user device 1202 and the reader device 1226 can be part of a single device, which may be a battery-operated device. In such an example, components of both the user device 1202 and the reader device 1226 may be associated with the single device. In some examples, the reader device 1226 can have a display integrated therewith, which can be in addition to (or as an alternative of) the display 1216 associated with the user device 1202.

The server(s) 1204 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1204 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1204 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1204 can include one or more processors 1228, one or more computer-readable media 1230, one or more I/O devices 1232, and one or more communication interfaces 1234. Each processor 1228 can be a single processing unit or a number of processing units, and can include single or multiple computing units or multiple processing cores. The processor(s) 1228 can be implemented as one or more microprocessors, microcomputers, microcontrollers, digital signal processors, central processing units, state machines, logic circuitries, and/or any devices that manipulate signals based on operational instructions. For example, the processor(s) 1228 can be one or more hardware processors and/or logic circuits of any suitable type specifically programmed or configured to execute the algorithms and processes described herein. The processor(s) 1228 can be configured to fetch and execute computer-readable instructions stored in the computer-readable media 1230, which can program the processor(s) 1228 to perform the functions described herein.

The computer-readable media 1230 can include volatile and nonvolatile memory and/or removable and non-removable media implemented in any type of technology for storage of information, such as computer-readable instructions, data structures, program components, or other data. Such computer-readable media 1230 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1204, the computer-readable media 1230 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1230 can be used to store any number of functional components that are executable by the processor(s) 1228. In many implementations, these functional components comprise instructions or programs that are executable by the processors 1228 and that, when executed, specifically configure the one or more processors 1228 to perform the actions attributed above to the service provider 812 and/or payment processing service. Functional components stored in the computer-readable media 1230 can optionally include a merchant component 1236, a training component 1238, and one or more other components and data 1240. Such other components can include the banking component 104, the payroll component 106, and/or the payment component 108 of FIG. 1.

The merchant component 1236 can be configured to receive transaction data from POS systems, such as the POS system 1224 described above with reference to FIG. 12. The merchant component 1236 can transmit requests (e.g., authorization, capture, settlement, etc.) to payment service server computing device(s) to facilitate POS transactions between merchants and customers. The merchant component 1236 can communicate the successes or failures of the POS transactions to the POS systems.

The training component 1238 can be configured to train models using machine-learning mechanisms. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1202 and/or the server(s) 1204 for use at a time after the data models have been trained (e.g., at runtime).

The one or more other components and data 1240 can include the banking component 104, the payroll component 106, and/or the payment component 108 of FIG. 1, the functionality of which is described, at least partially, above. Further, the one or more other components and data 1240 can include programs, drivers, etc., and the data used or generated by the functional components. Further, the server(s) 1204 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. components are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 1230 can additionally include an operating system 1242 for controlling and managing various functions of the server(s) 1204.

The communication interface(s) 1234 can include one or more interfaces and hardware components for enabling communication with various other devices, such as over the network(s) 1206 or directly. For example, communication interface(s) 1234 can enable communication through one or more network(s) 1206, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1202 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1204 can further be equipped with various I/O devices 1232. Such I/O devices 1232 can include a display, various user interface controls (e.g., buttons, joystick, keyboard, mouse, touch screen, biometric or sensory input devices, etc.), audio speakers, connection ports and so forth.

In at least one example, the system 1200 can include a datastore 1244 that can be configured to store data that is accessible, manageable, and updatable. In some examples, the datastore 1244 can be integrated with the user device 1202 and/or the server(s) 1204. In other examples, as shown in FIG. 12, the datastore 1244 can be located remotely from the server(s) 1204 and can be accessible to the server(s) 1204. The datastore 1244 can comprise multiple databases and/or servers connected locally and/or remotely via the network(s) 1206.

In at least one example, the datastore 1244 can store user profiles, which can include merchant profiles, customer profiles, user profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 612.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

User profiles can include user data including, but not limited to, user information (e.g., name, phone number, address, banking information, etc.), user preferences (e.g., learned or user-specified), payment history data (e.g., to other users, to third-parties, to merchants, etc.), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), user service data, etc.

Furthermore, in at least one example, the datastore 1244 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1244 can store additional or alternative types of data as described herein.

### EXAMPLE CLAUSES

A. A computer-implemented method implemented at least in part by at least one computing device of a service provider, the method comprising: receiving, via a user interface presented by a mobile payment application associated with the service provider, information about a credential associated with a user account of a user and a third-party service provider; determining a level of risk associated with the credential based at least in part on the information about the credential; in response to a determination that the level of risk satisfies a threshold: sending an instruction to the mobile payment application to provision the credential to the third-party service provider, wherein based at least in part on sending the instruction, the mobile payment application sends the credential to at least one computing device of the third-party service provider, and wherein based at least in part on the sending of the credential, a session is established between the mobile payment application and the at least one computing device of the third-party service provider; and receiving, from the mobile payment application, user data associated with the user account of the user, wherein the user data is first received by the mobile payment application from the at least one computing device of the third-party service provider.
B. The computer-implemented method of clause A, wherein the credential comprises a password, a security key, log-in data, a passcode, or a single sign-on usable by the user to access services associated with at least the third-party service provider.
C. The computer-implemented method of clause A, wherein the level of risk is determined based at least in part on a number of service providers with which the credential is used.
D. The computer-implemented method of clause A, further comprising in response to a determination that the level of risk does not satisfy the threshold: sending the credential to the at least one computing device of third-party service provider, wherein based at least in part on the sending of the credential, a session is established between the at least one computing device of the service provider and the at least one computing device of the third-party service provider; and receiving, from the at least one computing device of the third-party service provider, user data associated with the user account of the user.
E. The computer-implemented method of clause A, wherein the user data is accessible via the session using one or more application programming interfaces.
F. The computer-implemented method of clause A, wherein the user data is accessible via the session using a scraping component.
G. The computer-implemented method of clause A, wherein the session is maintained for at least one of a period of time or until an occurrence of an event, wherein while the session is maintained, updated user data is received.
H. The computer-implemented method of clause A, further comprising sending, to the mobile payment application, a request for particular user data, wherein the user data received from the mobile payment application is a portion of the user data received by the mobile payment application, and wherein the portion corresponds to the particular user data.
I. The computer-implemented method of clause A, wherein the third-party service provider is a payroll service provider and the user data is payroll data.
J. A computer-implemented method comprising: within a first application context: receiving a request to establish a communication session with a third party service provider; and establishing the communication session to a user account of the third party service provider using user credentials; within a second application context: receiving related data of the first application context; storing the related data in association with the communication session; based at least in part on the request from a first application associated with the first application context, identifying data from the related data as identified data; verifying eligibility of the first application to access the identified data; and permitting access by the first application to the identified data on successful verification of eligibility.
K. One or more computer-readable non-transitory storage media embodying software comprising instructions operable when executed by at least one computing device of a service provider to: receive, via a user interface presented by a mobile payment application associated with the service provider, information about a credential associated with a user account of a user and a third-party service provider; determine a level of risk associated with the credential based at least in part on the information about the credential; and in response to a determination that the level of risk satisfies a threshold: send an instruction to the mobile payment application to provision the credential to the third-party service provider, wherein based at least in part on the sent instruction, the mobile payment application sends the credential to at least one computing device of the third-party service provider, and wherein based at least in part on the sent credential, a session is established between the mobile payment application and the at least one computing device of the third-party service provider; and receive, from the mobile payment application, user data associated with the user account of the user, wherein the user data is first received by the mobile payment application from the at least one computing device of the third-party service provider.
L. The computer-readable non-transitory storage media of clause K, wherein the credential comprises a password, a security key, log-in data, a passcode, or a single sign-on usable by the user to access services associated with at least the third-party service provider.
M. The computer-readable non-transitory storage media of clause K, wherein the level of risk is determined based at least in part on a number of service providers with which the credential is used.
N. The computer-readable non-transitory storage media of clause K, wherein, in response to a determination that the level of risk does not satisfy the threshold, the software is further operable when executed to: send the credential to the at least one computing device of third-party service provider, wherein based at least in part on the sent credential, a session is established between the at least one computing device of the service provider and the at least one computing device of the third-party service provider; and receive, from the at least one computing device of the third-party service provider, user data associated with the user account of the user.
O. The computer-readable non-transitory storage media of clause K, wherein the user data is accessible via the session using one or more application programming interfaces.
P. The computer-readable non-transitory storage media of clause K, wherein the user data is accessible via the session using a scraping component.
Q. The computer-readable non-transitory storage media of clause K, wherein the session is maintained for at least one of a period of time or until an occurrence of an event, wherein while the session is maintained, updated user data is received.
R. The computer-readable non-transitory storage media of clause K, wherein the software is further operable when executed to send, to the mobile payment application, a request for particular user data, wherein the user data received from the mobile payment application is a portion of the user data received by the mobile payment application, and wherein the portion corresponds to the particular user data.
S. The computer-readable non-transitory storage media of clause K, wherein the third-party service provider is a payroll service provider and the user data is payroll data.
T. One or more computer-readable non-transitory storage media embodying software comprising instructions operable when executed to: within a first application context: receive a request to establish a communication session with a third party service provider; and establish the communication session to a user account of the third party service provider using user credentials; within a second application context: receive related data of the first application context; storing the related data in association with the communication session; based at least in part on the request from a first application associated with the first application context, identify data from the related data as identified data; verify eligibility of the first application to access the identified data; and permit access by the first application to the identified data on successful verification of eligibility.
U. A system comprising one or more processors and a memory coupled to the processors comprising instructions executable by the processors, the processors being operable when executing the instructions to: receive, via a user interface presented by a mobile payment application associated with the service provider, information about a credential associated with a user account of a user and a third-party service provider; determine a level of risk associated with the credential based at least in part on the information about the credential; and in response to a determination that the level of risk satisfies a threshold: send an instruction to the mobile payment application to provision the credential to the third-party service provider, wherein based at least in part on the sent instruction, the mobile payment application sends the credential to at least one computing device of the third-party service provider, and wherein based at least in part on the sent credential, a session is established between the mobile payment application and the at least one computing device of the third-party service provider; and receive, from the mobile payment application, user data associated with the user account of the user, wherein the user data is first received by the mobile payment application from the at least one computing device of the third-party service provider.
V. The system of clause U, wherein the credential comprises a password, a security key, log-in data, a passcode, or a single sign-on usable by the user to access services associated with at least the third-party service provider.
W. The system of clause U, wherein the level of risk is determined based at least in part on a number of service providers with which the credential is used.
X. The system of clause U, wherein, in response to a determination that the level of risk does not satisfy the threshold, the processors are further operable when executing the instructions to: send the credential to the at least one computing device of third-party service provider, wherein based at least in part on the sent credential, a session is established between the at least one computing device of the service provider and the at least one computing device of the third-party service provider; and receive, from the at least one computing device of the third-party service provider, user data associated with the user account of the user.
Y. The system of clause U, wherein the user data is accessible via the session using one or more application programming interfaces.
Z. The system of clause U, wherein the user data is accessible via the session using a scraping component.
AA. The system of clause U, wherein the session is maintained for at least one of a period of time or until an occurrence of an event, wherein while the session is maintained, updated user data is received.
BB. The system of clause U, wherein the processors are further operable when executing the instructions to send, to the mobile payment application, a request for particular user data, wherein the user data received from the mobile payment application is a portion of the user data received by the mobile payment application, and wherein the portion corresponds to the particular user data.
CC. The system of clause U, wherein the third-party service provider is a payroll service provider and the user data is payroll data.
DD. A system comprising one or more processors and a memory coupled to the processors comprising instructions executable by the processors, the processors being operable when executing the instructions to: within a first application context: receive a request to establish a communication session with a third party service provider; and establish the communication session to a user account of the third party service provider using user credentials; within a second application context: receive related data of the first application context; storing the related data in association with the communication session; based at least in part on the request from a first application associated with the first application context, identify data from the related data as identified data; verify eligibility of the first application to access the identified data; and permit access by the first application to the identified data on successful verification of eligibility.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

What is claimed is:

1. A computer-implemented method comprising:
receiving, via a user interface presented by a mobile payment application associated with a service provider, a credential associated with a user account of a user and a third-party service provider;
sending, by the mobile payment application, the credential to at least one computing device of the third-party service provider, wherein based at least in part on the sending of the credential, a session is established between the mobile payment application and the at least one computing device of the third-party service provider;
receiving, by the mobile payment application and via the session, user data associated with the user account of the user from the at least one computing device of the third-party service provider; and
sending, by the mobile payment application and without having provided the credential to at least one computing device of the service provider, at least a portion of the user data to the at least one computing device of the service provider.

2. The computer-implemented method of claim 1, wherein the credential comprises a password, a security key, log-in data, a passcode, or a single sign-on usable by the user to access services associated with at least the third-party service provider.

3. The computer-implemented method of claim 1, further comprising:
receiving a request to obtain specific data;
converting the request to conform with the service provider;
sending the converted request to access specific data to the at least one computing device of the service provider, based on context of the request; and
receiving, from the at least one computing device of the service provider, an instruction to input a credential associated with the user account via the mobile payment application, and wherein the credential associated with the user account is received in response to receiving the instruction.

4. The computer-implemented method of claim 1, further comprising:
sending, by the mobile payment application to the at least one computing device of the service provider, a request for authenticating with the third-party service provider; and
receiving, by the mobile payment application, authentication details from the at least one computing device of the service provider, the authentication details having been communicated by the service provider to the third-party service provider;
wherein sending the credential to the at least one computing device of the third-party service provider comprises at least one of:
sending a particular credential specified in the authentication details;
sending the credential in a particular format specified in the authentication details;
sending the credential using a particular type of encryption specified in the authentication details;
sending, along with the credential, additional data specified in the authentication details;
sending the credential using a particular protocol specified in the authentication details; or
sending the credential with an indication of a particular type of authentication to implement specified in the authentication details.

5. The computer-implemented method of claim 1, wherein the user data is accessible via the session using at least one of:
one or more application programming interfaces; or
a scraping component.

6. The computer-implemented method of claim 1, further comprising maintaining the session for at least one of a period of time or until an occurrence of an event, wherein while the session is maintained, updated user data is received from the at least one computing device of the third-party service provider.

7. The computer-implemented method of claim 1, wherein the portion of the user data is determined based at least in part on a designation by the user.

8. One or more computer-readable non-transitory storage media embodying software comprising instructions operable when executed to:
receive, via a user interface presented by a mobile payment application associated with a service provider, a credential associated with a user account of a user and a third-party service provider;
send, by the mobile payment application, the credential to at least one computing device of the third-party service provider, wherein based at least in part on the sent credential, a session is established between the mobile payment application and the at least one computing device of the third-party service provider;
receive, by the mobile payment application and via the session, user data associated with the user account of the user from the at least one computing device of the third-party service provider; and
send, by the mobile payment application and without having provided the credential to at least one computing device of the service provider, at least a portion of the user data to the at least one computing device of the service provider.

9. The computer-readable non-transitory storage media of claim 8, wherein the credential comprises a password, a security key, log-in data, a passcode, or a single sign-on usable by the user to access services associated with at least the third-party service provider.

10. The computer-readable non-transitory storage media of claim 8, wherein the software is further operable when executed to:
receive a request to obtain specific data;
convert the request to conform with the service provider;
send the converted request to access specific data to the at least one computing device of the service provider, based on context of the request; and
receive, from the at least one computing device of the service provider, an instruction to input a credential associated with the user account via the mobile payment application, and wherein the credential associated with the user account is received in response to receiving the instruction.

11. The computer-readable non-transitory storage media of claim 8, wherein the software is further operable when executed to:
send, by the mobile payment application to the at least one computing device of the service provider, a request for authenticating with the third-party service provider; and
receive, by the mobile payment application, authentication details from the at least one computing device of the service provider, the authentication details having been communicated by the service provider to the third-party service provider;
wherein sending the credential to the at least one computing device of the third-party service provider comprises at least one of:
sending a particular credential specified in the authentication details;
sending the credential in a particular format specified in the authentication details;
sending the credential using a particular type of encryption specified in the authentication details;
sending, along with the credential, additional data specified in the authentication details;
sending the credential using a particular protocol specified in the authentication details; or
sending the credential with an indication of a particular type of authentication to implement specified in the authentication details.

12. The computer-readable non-transitory storage media of claim 8, wherein the user data is accessible via the session using at least one of:
one or more application programming interfaces; or
a scraping component.

13. The computer-readable non-transitory storage media of claim 8, wherein the portion of the user data is determined based at least in part on a request, from the at least one computing device of the service provider, for particular user data.

14. The computer-readable non-transitory storage media of claim 8, wherein the third-party service provider is a payroll service provider and the user data is payroll data.

15. A system comprising one or more processors and a memory coupled to the processors comprising instructions executable by the processors, the processors being operable when executing the instructions to:
receive, via a user interface presented by a mobile payment application associated with a service provider, a credential associated with a user account of a user and a third-party service provider;
send, by the mobile payment application, the credential to at least one computing device of the third-party service provider, wherein based at least in part on the sent credential, a session is established between the mobile payment application and the at least one computing device of the third-party service provider;
receive, by the mobile payment application and via the session, user data associated with the user account of the user from the at least one computing device of the third-party service provider; and
send, by the mobile payment application and without having provided the credential to at least one computing device of the service provider, at least a portion of the user data to the at least one computing device of the service provider.

16. The system of claim 15, wherein the credential comprises a password, a security key, log-in data, a passcode, or a single sign-on usable by the user to access services associated with at least the third-party service provider.

17. The system of claim 15, wherein the processors are further operable when executing the instructions to:
receive a request to obtain specific data;
convert the request to conform with the service provider;
send the converted request to access specific data to the at least one computing device of the service provider, based on context of the request; and
receive, from the at least one computing device of the service provider, an instruction to input a credential associated with the user account via the mobile payment application, and wherein the credential associated with the user account is received in response to receiving the instruction.

18. The system of claim 15, wherein the processors are further operable when executing the instructions to maintain the session for at least one of a period of time or until an occurrence of an event, wherein while the session is maintained, updated user data is received from the at least one computing device of the third-party service provider.

19. The system of claim 15, wherein the portion of the user data is determined based at least in part on a request, from the at least one computing device of the service provider, for particular user data.

20. The system of claim 15, wherein the third-party service provider is a payroll service provider and the user data is payroll data.
